(19) United States
(12) Patent Application Publication
(10) Pub. No.: US 2013/0169226 A1
(43) Pub. Date: Jul. 4, 2013

(54) ELECTRICITY TRANSFER SYSTEM FOR MODIFYING AN ELECTRIC VEHICLE CHARGING STATION AND METHOD OF PROVIDING, USING, AND SUPPORTING THE SAME

(71) Applicant: Colin Read, San Francisco, CA (US)

(72) Inventor: Colin Read, San Francisco, CA (US)

(73) Assignee: Electric Transportation Engineering corporation d/b/a ECOtality North America, Phoenix, AZ (US)

(21) Appl. No.: 13/341,274

(22) Filed: Dec. 30, 2011

(51) Int. Cl. H02J 7/00

(52) U.S. Cl. 320/109; 320/137

(57) ABSTRACT

Some embodiments include an electricity transfer system for modifying an electric vehicle charging station. Other embodiments of related systems and methods are also disclosed.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to an electricity transfer system, and relates more particularly to an electricity transfer system for modifying an electric vehicle charging station and methods of providing, using, and supporting the same.

### DESCRIPTION OF THE BACKGROUND

A “smart” electric vehicle charging station can offer functionality that is not available from a “dumb” electric vehicle charging station. Meanwhile, one smart electric vehicle charging station may offer more functionality than another smart electric vehicle charging station. Nonetheless, whether upgrading an existing electric vehicle charging station or originally providing an electric vehicle charging station, components for implementing the functionality of a smart electric vehicle charging station can be expensive, and integrating and/or installing those components of the electric vehicle charging station can be complicated, time consuming, and/or expensive, as well. Accordingly, a need or potential for benefit exists for an electricity transfer system for easily, efficiently, and/or inexpensively modifying, upgrading, and/or adapting an electric vehicle charging station to provide smart electric vehicle charging station functionality.

### BRIEF DESCRIPTION OF THE DRAWINGS

To facilitate further description of the embodiments, the following drawings are provided in which:

FIG. 1 illustrates a representative block diagram of an electricity transfer system (ETS) for modifying an electric vehicle charging station (EVCS), according to an embodiment

FIG. 2 illustrates an exemplary adapter comprising an integrated user interface, according to the embodiment of FIG. 1;

FIG. 3 illustrates the exemplary adapter of FIG. 2 coupled to an exemplary electrical connector, according to the embodiment of FIG. 1;

FIG. 4 illustrates the exemplary adapter 204 of FIG. 2 coupled to the exemplary electrical connector of FIG. 3 and to an exemplary electric vehicle rechargeable energy storage system (EVRESS) of an electric vehicle, according to the embodiment of FIG. 1;

FIG. 5 illustrates another exemplary adapter, according to the embodiment of FIG. 1;

FIG. 6 illustrates a flow chart for an embodiment of a method of providing an electricity transfer system for modifying an electric vehicle charging station;

FIG. 7 illustrates a flow chart for an exemplary procedure of providing an adapter, according to the embodiment of FIG. 6;

FIG. 8 illustrates a flow chart for an exemplary process of providing an operations module, according to the embodiment of FIG. 7;

FIG. 9 illustrates a flow chart of an exemplary procedure of providing an intelligence module, according to the embodiment of FIG. 6;

FIG. 10 illustrates a flow chart for an embodiment of a method for modifying an electric vehicle charging station;

FIG. 11 illustrates a flow chart of an exemplary procedure of coupling an adapter to the electric vehicle charging station to receive electricity from the electric vehicle charging station, according to the embodiment of FIG. 10;

FIG. 12 illustrates a flow chart of an exemplary procedure of controlling the adapter with an intelligence module such that the electric vehicle charging station and the adapter operate as a smart electric vehicle charging station, according to the embodiment of FIG. 10;

FIG. 13 illustrates a flow chart of an exemplary process of controlling an operations module of the adapter, according to the embodiment of FIG. 10;

FIG. 14 illustrates a flow chart for an embodiment of a method of supporting an adapter for modifying an electric vehicle charging station such that the electric vehicle charging station and the adapter operate as a smart electric vehicle charging station;

FIG. 15 illustrates a computer system that is suitable for implementing an embodiment of an intelligence module computer system, an electricity transfer system network computer system, an electric grid computer system, an electric vehicle charging station computer system, and/or an energy management system computer system; and

FIG. 16 illustrates a representative block diagram of exemplary components and/or circuitry included in exemplary circuit boards inside a chassis of the computer system of FIG. 15.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

The terms “discrete” and “separate” can each be understood to describe the physical relationship of two or more elements with respect to one another. Specifically, although these terms are sometimes used synonymously, for the purposes of this disclosure, the term “discrete” can refer to two or more elements that remain independent of one another when mechanically coupled together (i.e., making physical contact at the physical boundaries of those elements) while the term “separate” can refer to two or more elements that are not mechanically coupled together (i.e., making neither direct nor indirect physical contact) at that time. The term “discrete” can also describe distinguishable relationships from that of the terms “integral” and “integrated,” which can be construed according to their ordinary meanings. Accordingly, discrete elements can generally, and often intentionally, be more readily decoupled from one another than integrated and/or integral elements, which may not be able to be or at least may not be intended to be decoupled from one another at all.

### DETAILED DESCRIPTION OF EXAMPLES OF EMBODIMENTS

Some embodiments include an electricity transfer system (ETS) for modifying an electric vehicle charging station (EVCS). The EVCS is configured to be coupled to an electric grid to receive electricity from the electric grid, and the EVCS is configured to be coupled to an electric vehicle rechargeable energy storage system (EVRESS) of an electric vehicle to make the electricity available to the EVRESS. The ETS comprises an adapter and an intelligence module. The adapter is configured (a) to be coupled to the EVCS to receive the electricity from the EVCS and (b) to be coupled to the EVRESS to make the electricity available to the EVRESS. The intelligence module is configured to control the adapter. The EVCS is configured to operate as a dumb EVCS when the adapter is uncoupled from the EVCS. Meanwhile, when the adapter is coupled to the EVCS, the EVCS, the adapter, and the intelligence module can operate as a smart EVCS.

Various embodiments include a method of providing an electricity transfer system (ETS) for modifying an EVCS. The EVCS is configured to be coupled to an electric grid to receive electricity from the electric grid, and the EVCS is configured to be coupled to an electric vehicle rechargeable energy storage system (EVRESS) of an electric vehicle to make the electricity available to the EVRESS. The method comprises: providing an adapter configured (a) to be coupled to the EVCS to receive the electricity from the EVCS and (b) to be coupled to the EVRESS to make the electricity available to the EVRESS; and providing an intelligence module configured to control the adapter. The EVCS is configured to operate as a dumb EVCS when the adapter is uncoupled from the EVCS. Meanwhile, when the adapter is coupled to the EVCS, the EVCS, the adapter, and the intelligence module can operate as a smart EVCS.

Further embodiments include a method for modifying a dumb electric vehicle charging station (EVCS). The dumb EVCS is configured to be coupled to an electric grid to receive electricity from the electric grid, and the EVCS is configured to be coupled to an electric vehicle rechargeable energy storage system (EVRESS) of an electric vehicle to make the electricity available to the EVRESS. The method comprises: coupling an adapter to the dumb EVCS to receive the electricity from the dumb EVCS; coupling the adapter to the EVRESS to make the electricity available to the EVRESS; and after coupling the adapter to the dumb EVCS and after coupling the adapter to the EVRESS, controlling the adapter such that the dumb EVCS and the adapter operate as a smart EVCS.

Other embodiments include a method of supporting an adapter for modifying a dumb electric vehicle charging station (EVCS) such that the dumb EVCS and the adapter can operate as a smart EVCS. The dumb EVCS is configured to be coupled to an electric grid to receive electricity from the electric grid, and the dumb EVCS is configured to be coupled to an electric vehicle rechargeable energy storage system (EVRESS) of an electric vehicle to make the electricity available to the EVRESS. The method comprises: maintaining an electricity transfer system network (ETSN) computer system of an electricity transfer system network (ETSN); and communicating with the adapter, where the adapter is configured to control (a) when the adapter receives the electricity from the dumb EVCS and/or (b) when the adapter makes the electricity available to the EVRESS, in order to determine (a) when the adapter receives the electricity from the dumb EVCS and/or (b) when the adapter makes the electricity available to the EVRESS.

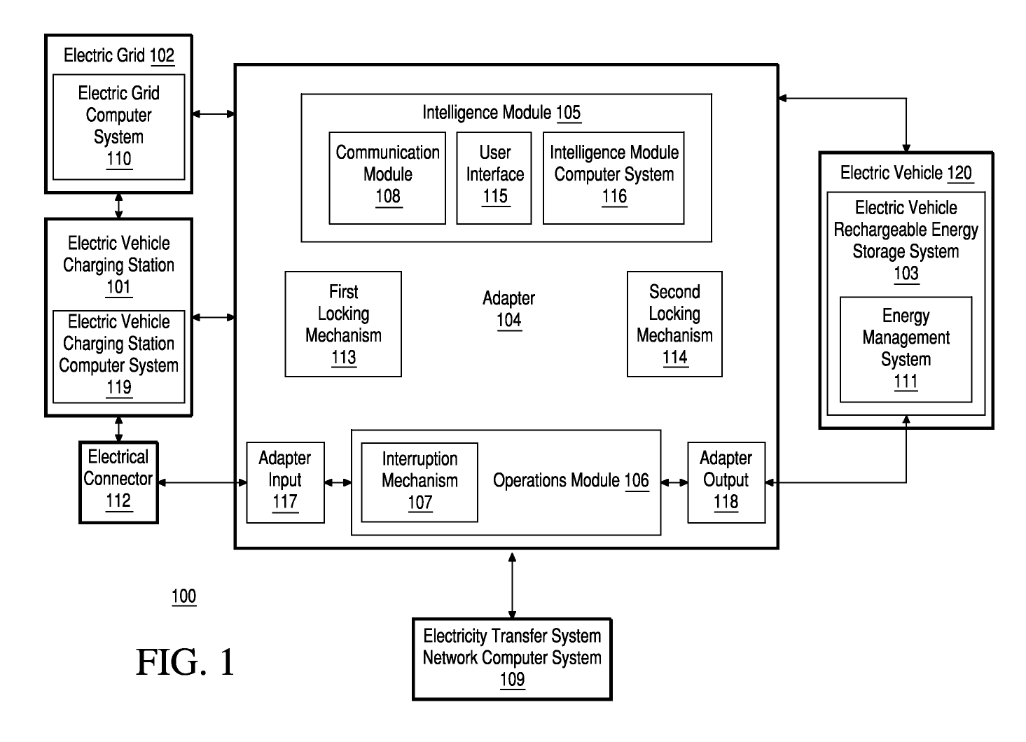

Turning to the drawings, FIG. 1 illustrates a representative block diagram of an electricity transfer system (ETS) 100 for modifying, upgrading, and/or adapting electric vehicle charging station (EVCS) 101, according to an embodiment. ETS 100 is merely exemplary and is not limited to the embodiments presented herein. ETS 100 can be employed in many different embodiments or examples not specifically depicted or described herein.

EVCS 101 is configured to be coupled to electric grid 102 so that EVCS 101 can receive electricity from electric grid 102 and/or so that EVCS 101 can make electricity available to electric grid 102. Meanwhile, EVCS 101 is also configured to be coupled to one or more electric vehicle rechargeable energy storage systems (EVRESS's) (e.g., EVRESS 103) of one or more electric vehicles (e.g., electric vehicle 120), respectively. As a result, EVCS 101 can make electricity available to the EVRESS('s) (e.g., the electricity received from electric grid 102), and/or EVCS 101 can receive electricity from the EVRESS('s) (e.g., to be made available to electric grid 102). Said another way, EVCS 101 can be configured to transfer electricity from electric grid 102 to the EVRESS('s) (i.e., grid-to-vehicle electricity transfer) to charge the EVRESS('s) and/or to transfer electricity from the EVRESS('s) to electric grid 102 (i.e., vehicle-to-grid electricity transfer) to provide ancillary services to electric grid 102. Still, in many embodiments, although EVCS 101 may be mechanically configured to provide both grid-to-vehicle and vehicle-to-grid electricity transfers, EVCS 101 may not be operationally configured to provide vehicle-to-grid electricity transfers. Accordingly, among various other additionally permitted functionalities ETS 100 can provide, ETS 100 can permit EVCS 101 to implement such vehicle-to-grid functionalities, as described in further detail below. For simplicity and clarity of illustration, the relationship of EVCS 101 with respect to the EVRESS('s) may, in various instances, be described and/or illustrated only with respect to EVRESS 103, but these concepts could apply equally to multiple EVRESS('s), when applicable.

As pertaining to vehicle-to-grid electricity transfers, exemplary ancillary services can comprise (1) reactive electric power/electric voltage control, (2) electric loss compensation, (3) electric load following, (4) electric grid protection, and/or (5) electric energy balancing, etc. Reactive electric power/electric voltage control can refer to providing electricity to and/or drawing electricity from electric grid 102 in an effort to maintain a balanced or steady-state electric power, electric voltage, and/or frequency of the electricity in electric grid 102. Meanwhile, electric loss compensation can refer to compensating for electric power losses in electricity as the electricity passes from electricity generation devices to electric loads. Electric load following can refer to quickly providing electricity to and/or drawing electricity from electric grid 102 (e.g., for approximately minute intervals) in response to approximately real time and/or near real time fluctuations (e.g., minute to minute) of electric load versus generated electricity. Electric energy balancing can be similar to electric load following, but can occur for longer intervals (e.g., multiple minutes to hours) and can be in response to fluctuations detected over longer time intervals (e.g., multiple minutes to hours). Finally, electric grid protection can refer to (a) compensating for large spikes in electricity in electric grid 102 to prevent those spikes from damaging electric grid 102, (b) improving the operational efficiency of electric grid 102, and/or (c) improving the stability of electric grid 102.

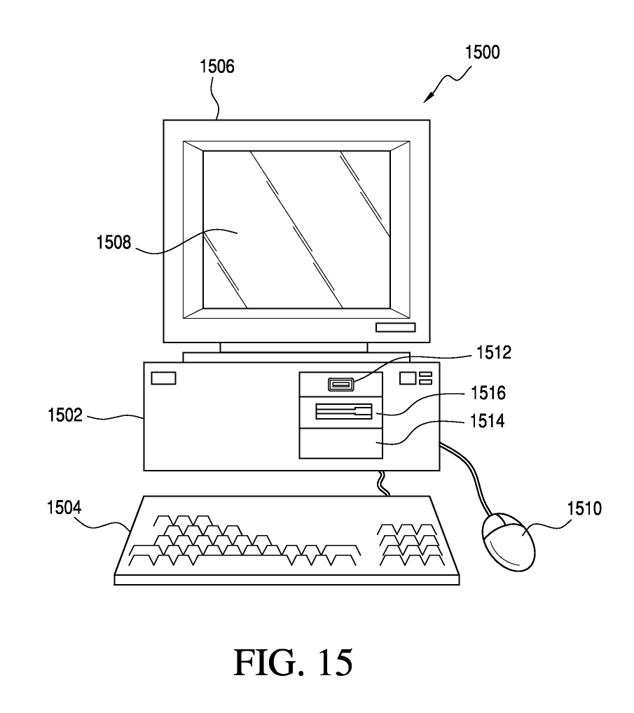

EVCS 101 can comprise electric vehicle supply equipment. The electric vehicle supply equipment can be any suitable alternating current and/or direct current electric vehicle supply equipment. For example, EVCS 101 can comprise electric vehicle supply equipment configured according to any one of the Society of Automotive Engineers (SAE) International electric vehicle supply equipment standards (e.g., Level 1, Level 2, and/or Level 3) and/or the International Electrotechnical Commission (IEC) standards (e.g., Mode 1, Mode 2, Mode 3, and/or Mode 4). In many embodiments, EVCS 101 can comprise electric vehicle charging station (EVCS) computer system 119, which can be configured to operate EVCS 101. EVCS computer system 119 can be similar or identical to computer system 1500 (FIG. 15), as described below.

Meanwhile, EVCS 101 can comprise and/or can be configured to operate as a dumb electric vehicle charging station (EVCS). The term “dumb EVCS” can be understood in context with the related term “smart electric vehicle charging station (EVCS).” Generally speaking, the term “smart EVCS” can refer to any EVCS having the capability to leverage (e.g., in real time) resources external to the EVCS, such as, for example, (a) one or more electricity transfer system networks (ETSNs); (b) electricity transfer system network (ETSN) computer systems (e.g., ETSN computer system 109) associated therewith; (c) one or more electric grid computer systems (e.g., electric grid computer system 110), (d) one or more energy management systems (EMSs) (e.g., EMS 111), etc.), and/or (e) one or more original equipment manufacturer networks (OEM) networks to enhance the functionality of the EVCS. Meanwhile, in some examples, the term “dumb EVCS” can refer to any EVCS that lacks the capability to leverage such external resources and/or, in other examples, can be understood relative to the term “smart EVCS” to refer to any EVCS having the ability to leverage external resources to a lesser extent and/or to an alternative extent than a respective “smart EVCS.” Accordingly, as described below, ETS 100 is configured to modify, upgrade, and/or adapt EVCS 101 to comprise and/or to operate as a smart EVCS rather than a dumb EVCS. Various advantages provided to users of, operators of, and/or third parties to EVCS 101 by modifying, upgrading, and/or adapting EVCS 101 are described in further detail below.

With respect to the external resources, an ETSN can refer to a network configured to facilitate the operation (e.g., in real time) of multiple EVCS's by supporting (e.g., remotely and/or centrally) the EVCS's with external resources (e.g., computer processing, data storage and/or aggregation, administration and/or billing, etc.) to provide additional functionality to the EVCS's. In many examples, the operator of the ETSN can also own, operate, and/or support any or all of the EVCS's.

Accordingly, ETS 100 can permit EVCS 101 to leverage and, thereby, effectively become part of a new ETSN. As indicated previously, this situation can occur even where EVCS 101 is already part of a different ETSN, such as, for example, where the new ETSN offers functionality that is not available with the different ETSN. For example, if EVCS 101 is part of a first subscription network, ETS 100 can permit EVCS 101 to also operate within a second or different subscription network. Furthermore, in many examples, without ETS 100, EVCS 101 may otherwise be unable to leverage any ETSN. This scenario does not imply that an ETSN operator may not own and/or operate EVCS 101, but rather, indicates that the ETSN operator is unable to support EVCS 101 with (or support EVCS 101 to the same degree as) the ETSN in the absence of ETS 100. It follows that ETSN could comprise one or more dumb EVCS's (e.g., EVCS 101) as well as one or more smart EVCS's (e.g., having lesser, alternative, and/or identical functionality to EVCS 101 when modified by ETS 100). Likewise, in some examples, EVCS 101 could simultaneously leverage multiple ETSNs provided the operators of the ETSNs so permit.

Each ETSN can be administrated via an electricity transfer system network (ETSN) computer system (e.g., ETSN computer system 109) associated therewith by the operating entity using and/or managing the ETSN computer system. For example, users of an ETSN and/or ETS 100 can be customers of the operating entity, and in some embodiments, users of the ETSN and/or ETS 100 can establish user accounts with the operating entity after the operating entity permits such users to use the ETSN. Furthermore, users of the ETSN and/or ETS 100 can establish user profiles corresponding to their user accounts that permit such users to manage their user accounts (e.g., provide user data, make payments for using the ETSN, ETS 100, and/or EVCS 101, etc.), to review electric vehicle data and/or electric vehicle rechargeable energy storage system (EVRESS) data for their electric vehicles (as described below), to reserve any of the various electric vehicle charging stations of the electricity transfer system network, etc. Similarly, the operating entity can maintain manager profiles (e.g., via one or more computer databases of the ETSN computer system (e.g., ETSN computer system 109)) corresponding to the user accounts that aggregate user data (e.g., personal information, financial and/or accounting information, etc.), electric vehicle data, and/or EVRESS data relating to the users (the relevance of which is discussed in further detail below) and that make available the user data, the electric vehicle data, and/or the EVRESS data to the users (e.g., via the user profiles) and to the operating entity. Users can access and/or manage their user profiles via a user interface (e.g., user interface 115) of an intelligence module (e.g., intelligence module 105) of ETS 100, as described below, and/or remotely via their personal computing device (e.g., a desktop computer system, a laptop computer system, and/or any suitable mobile electronic computer system, such as, for example, a tablet computer system, and/or a smart phone, etc.).

Each ETSN can comprise a use structure dictating whether and to what extent users can use that ETSN. For example, users of an ETSN can become members of the ETSN by, for example, paying an incremental (e.g., monthly, annually, etc.), one-off, and/or pay-per-use membership fee(s) to that ETSN operator. In some embodiments, users of the ETSN can also use ETSN as guests. Generally, members of the ETSN can have more privileges and access to more services than guests of the ETSN. Meanwhile, in various embodiments, membership in an ETSN can be tiered such that some members have more privileges and access to more services than other members. However, premium memberships can cost more in membership fees than other memberships.

Meanwhile, electric grid 102 can comprise one or more commercial electric grids and/or one or more personal electric grids. A commercial electric grid can refer to any conventional electric network operated by one or more utility companies, and a personal electric grid can refer to a personal electricity generation/distribution system owned and/or operated by one or more users of ETS 100 and/or one or more third parties other than utility companies. For example, a personal electric grid can comprise one or more photovoltaic panels, one or more wind turbines, one or more gas-powered generators, etc. and any electrical circuitry associated therewith. The commercial electric grid(s) and/or personal electric grid(s) can be administered via electric grid computer system 110 by one or more operators of electric grid 102. In many examples, a commercial electric grid can comprise one or more electrical networks of varying scale. Accordingly, a commercial electric grid can be defined by a geographical area (e.g., one or more continents, countries, states, municipalities, ZIP codes, regions, etc.) and/or defined via some other context, such as, for example, by the utility company or companies that operate the commercial electric grid. Meanwhile, the commercial electric grids can be administrated via electric grid computer system 110 by the one or more utility companies managing and/or operating the commercial electric grids.

Likewise, each EVRESS (e.g., EVRESS 103) can be configured to provide electricity to its associated electric vehicle (e.g., electric vehicle 120) to provide motive (e.g., traction) electrical power to that electric vehicle and/or to provide electricity to any electrically operated components of that electric vehicle. In some embodiments, each EVRESS (e.g., EVRESS 103) can be configured with and/or can comprise an electricity transfer rating of greater than or equal to approximately (⅛) C (e.g., approximately (¼) C, approximately (⅓) C, approximately (½) C, approximately 1 C, approximately 2 C, approximately 3 C, etc.), where the electricity transfer rating refers to an electricity charge and/or discharge rating of that EVRESS in terms of the electric current capacity of the EVRESS in ampere-hours. Furthermore, each EVRESS (e.g., EVRESS 103) can also be configured with and/or can comprise an electric energy storage capacity of greater than or equal to approximately 1 kiloWatt-hour (kW-hr). For example, each EVRESS (e.g., EVRESS 103) can be configured with and/or can comprise an electric energy storage capacity of greater than or equal to approximately 20 kW-hrs and less than or equal to approximately 50 kW-hrs. In further examples, each EVRESS (e.g., EVRESS 103) can be configured with and/or can comprise an electric energy storage capacity of greater than or equal to approximately 5 kW-hrs and less than or equal to approximately 100 kW-hrs.

In specific examples, each EVRESS (e.g., EVRESS 103) can comprise (a) one or more batteries and/or one or more fuel cells, (b) one or more capacitive energy storage systems (e.g., super capacitors such as electric double-layer capacitors), and/or (c) one or more inertial energy storage systems (e.g., one or more flywheels). In many embodiments, the one or more batteries can comprise one or more rechargeable and/or non-rechargeable batteries. For example, the one or more batteries can comprise one or more lead-acid batteries, valve regulated lead acid (VRLA) batteries such as gel batteries and/or absorbed glass mat (AGM) batteries, nickel-cadmium (NiCd) batteries, nickel-zinc (NiZn) batteries, nickel metal hydride (NiMH) batteries, zebra (e.g., molten chloroaluminate (NaAlCl₄)) batteries, and/or lithium (e.g., lithium-ion (Li-ion)) batteries.

Meanwhile, each electric vehicle (e.g., electric vehicle 120) can comprise any full electric vehicle, any hybrid vehicle, and/or any other grid-connected vehicle. In the same or different embodiments, each electric vehicle (e.g., electric vehicle 120) can comprise any one of a car, a truck, motorcycle, a bicycle, a scooter, a boat, a train, an aircraft, an airport ground support equipment, and/or a material handling equipment (e.g., a fork-lift), etc.

Referring again to the external resources able to be leveraged by EVCS 101 when modified by ETS 100, each EVRESS (e.g., EVRESS 103) and/or each electric vehicle (e.g., electric vehicle 120) can comprise an energy management system (EMS) (e.g., EMS 111). For example, where the EVRESS (e.g., EVRESS 103) comprises one or more batteries, the EMS (e.g., EMS 111) can comprise a battery EMS. The EMS can comprise varying levels of sophistication. For example, in some embodiments, the EMS can be configured to use charging algorithms to calculate dynamic charging conditions of the EVRESS (e.g., EVRESS 103), which are described in greater detail below. Meanwhile, the EMS can also be configured to utilize other charging algorithms to calculate and/or can store static charging conditions of the EVRESS (e.g., EVRESS 103), which are also described in greater detail below. In other embodiments, where the EMS (e.g., EMS 111) comprises less sophistication, functionality permitting the EMS to calculate dynamic charging conditions and/or to calculate static charging conditions can be omitted. For example, in these embodiments, the EMS (e.g., EMS 111) can be programmed to merely store static charging conditions of the EVRESS (e.g., EVRESS 103).

EVCS 101 can comprise and/or can be configured to be coupled with one or more electrical connectors (e.g., electrical connector 112). The electrical connector(s) can be coupled to EVCS 101 to receive electricity from EVCS 101. Each of the one or more electrical connectors can be coupled to EVCS 101 by a corresponding electrical cable. Accordingly, EVCS 101 and/or each of the one or more electrical connectors, respectively, can comprise the electrical cable(s). Meanwhile, each of the electrical connector(s) can be coupled to one EVRESS of the EVRESS('s) (e.g., EVRESS 103) to make electricity available to that EVRESS (e.g., EVRESS 103).

The electrical connector(s) can comprise any suitable electrical connector(s) for coupling EVCS 101 to the EVRESS('s) (e.g., EVRESS 103). In many embodiments, the electrical connector(s) can comprise one or more IEC 62196 approved electrical connector(s). For example, the electrical connector(s) can comprise one or more SAE J1772 electrical connectors, one or more VDE-AR-E 2623-2-2 (Mennekes) electrical connectors, one or more JARI (CHAdeMO) electrical connectors, etc., and/or any suitable combination thereof.

The electrical connector(s) can be configured to communicate with the electric vehicle(s) (e.g., electric vehicle 120), the EVRESS('s) (e.g., EVRESS 103), and/or the EMS('s) (e.g., EMS 111) using an electric vehicle bus standard, such as, for example, the controller-area network (CAN) bus standard to permit communication between EVCS 101 and with the electric vehicle(s) (e.g., electric vehicle 120), the EVRESS('s) (e.g., EVRESS 103), and/or the EMS('s) (e.g., EMS 111). The electrical connector(s) (e.g., electrical connector 112) can also be configured to transmit a pilot signal between EVCS 101 and the electric vehicle(s) (e.g., electric vehicle 120), the EVRESS('s) (e.g., EVRESS 103), and/or the EMS('s) (e.g., EMS 111) when the electrical connector(s) are coupled with and/or ready to make electricity available to the EVRESS('s) (e.g., EVRESS 103).

With still further respect to the external resources, an OEM network can refer to a network configured to facilitate the operation (e.g., in real time) of EVRESS 103, EMS 111 and/or electric vehicle 120 by supporting (e.g., remotely and/or centrally) EVRESS 103, EMS 111 and/or electric vehicle 120 with external resources (e.g., computer processing, data storage and/or aggregation, vehicle telematics, etc.) to provide additional functionality to EVRESS 103, EMS 111, and/or electric vehicle 120. In many examples, the operator of the OEM network can be one or more original equipment manufacturers of EVRESS 103, EMS 111, and/or electric vehicle 120. Similar to each ETSN as described above, each OEM network can be administrated via an original equipment manufacturer (OEM) network computer system associated therewith by the operating entity using and/or managing the OEM network computer system.

In implementation, ETS 100 comprises adapter 104, intelligence module 105, and communication module 108. Adapter 104 comprises operation module 106 and can comprise first locking mechanism 113 and/or second locking mechanism 114. Meanwhile, operation module 106 can comprise interruption mechanism 107, and intelligence module 105 can comprise communication module 108 and user interface 115.

In some embodiments, adapter 104 comprises intelligence module 105. Accordingly, in these embodiments, adapter 104 can also comprise user interface 115, and user interface 115 can be integral with adapter 104. Meanwhile, in other embodiments, adapter 104 and intelligence module 105 can be discrete and/or separate from each other. Accordingly, in these embodiments, adapter 104 can be configured such that intelligence module 105 can be removably coupled with adapter 104.

ETS 100 can comprise EVCS 101, ETSN computer system 109, electric grid computer system 110, EMS 111, and/or the OEM network computer system. Likewise, in many embodiments, intelligence module 105 can comprise intelligence module computer system 116. In implementation, ETSN computer system 109, electric grid computer system 110, EMS 111, intelligence module computer system 116, and/or the OEM network computer system can each be similar or identical to computer system 1500 (FIG. 15), which is described in further detail below. In many embodiments, ETSN computer system 109 and/or electric grid computer system 110 can be located remotely from EVCS 101. For example, ETSN computer system 109 can be operated at a site owned and/or operated by the operator of the corresponding ETSN. Likewise, electric grid computer system 110 can be operated at a site owned and/or operated by the operator(s) of electric grid 102. Meanwhile, EMS 111 can typically be integrated with EVRESS 103 and/or electric vehicle 120.

Adapter 104 can comprise adapter input 117 and adapter output 118. Adapter input 117 and adapter output 118 are so named for convenience of illustration and should not necessarily be construed as limiting adapter 104 to mono-directional transfer of electricity. For example, in many embodiments, adapter 104 is also configured to permit bi-directional transfer of electricity.

Moving onward, adapter 104 and/or adapter input 117 are configured to be coupled to EVCS 101 (e.g., via adapter input 117) so that adapter 104 can receive electricity from EVCS 101. In some embodiments, adapter 104 and/or adapter input 117 can be removably, directly coupled to EVCS 101. For example, in these embodiments, adapter 104 and/or adapter input 117 can be removably, directly coupled to EVCS 101 where electrical connector 112 and the electrical cable corresponding to electrical connector 112 are part of EVCS 101. Accordingly, in these same embodiments, electrical connector 112 can be removably coupled directly (e.g., where adapter 104 comprises the electrical cable for electrical connector 112, and vice versa) or indirectly (e.g., where adapter 104 and the electrical cable for electrical connector 112 are discrete from each other) to adapter 104. Meanwhile, in other embodiments where adapter 104 and/or adapter input 117 are removably, directly coupled to EVCS 101, adapter 104 and/or adapter input 117 can comprise electrical connector 112 and/or its electrical cable.

Meanwhile, in other embodiments, adapter 104 and/or adapter input 117 can be removably, indirectly coupled to EVCS 101. For example, in these embodiments, adapter 104 and/or adapter input 117 can be removably coupled directly to electrical connector 112, which in turn is removably coupled to EVCS 101 (e.g., by the electrical cable). In other examples, adapter 104 and/or adapter input 117 can be removably, directly coupled to the electrical cable configured to couple electrical connector 112 to EVCS 101.

Likewise, adapter 104 and/or adapter output 118 are also configured to be coupled to EVRESS 103 so that adapter 104 can make electricity available to EVRESS 103. Adapter 104 and/or adapter output 118 can be removably coupled to EVRESS 103 directly or indirectly, corresponding to the various examples provided above with respect to adapter 104 and adapter input 117. Accordingly, to summarize generally, adapter 104 can be interposed in any suitable coupling configuration permitting coupling of adapter 104 between EVCS 101 and EVRESS 103.

In many embodiments, adapter input 117 and/or adapter output 118 can be configured to be universal and/or adaptable to permit adapter 104 and/or ETS 100 to operate with multiple configurations of electrical connectors (e.g., electrical connector 112). Accordingly, adapter 104, intelligence module 105, and/or operations module 106 can also be configured to permit adapter 104 and/or ETS 100 to operate with multiple configurations of EVCS's (e.g., EVCS 101), electrical connectors (e.g., electrical connector 112), and/or EVRESS's (e.g., EVRESS 103) such that ETS 100 can be substantially and/or completely universal.

Adapter 104 can be portable such that users of ETS 110 can transport adapter 104 in electric vehicle 120 and in some examples, on their person. Accordingly, although adapter 104 can be any suitable size, shape, and/or weight, in many embodiments, adapter 104 is configured to comprise a size, shape, and/or weight conducive to portability.

For example, in some embodiments, adapter 104 can be generally tubular in shape with a circular cross section (e.g., a cylinder) or a polygonal cross section, although the shape can vary and/or be altered somewhat when adapter 104 comprises and/or is coupled with intelligence module 105. For example, adapter 104 can approximately resemble a 355 milliliter aluminum can, such as, for example, for containing a soft-drink. In these embodiments, adapter 104 can comprise a length dimension of greater than or equal to approximately 10 centimeters and less than or equal to approximately 26 centimeters. Meanwhile, adapter 104 can comprise a lateral dimension (e.g., diameter and/or width) of greater than or equal to approximately 5 centimeters and less than or equal to approximately 13 centimeters. In many embodiments, the lateral dimension of adapter 104 can be sized according to the lateral dimensions of electrical connector 112 and/or its electrical cable (e.g., to approximately match or be slightly larger).

Likewise, adapter 104 can remain discrete from EVCS 101 when adapter 104 is coupled to EVCS 101, such as, for example, to increase the portability of adapter 104. Accordingly, in many embodiments, because adapter 104 is portable and/or discrete from EVCS 101, ETS 100 can be implemented and/or adapter 104 can be used with any suitable EVCS (e.g., EVCS 101, another EVCS, etc.). Thus, in some examples, adapter 104 can be referred to and/or can operate as a dongle.

As indicated above, adapter 104 can comprise electrical connector 112, and vice versa. In many examples, whether adapter 104 and electrical connector 112 are one and the same can be decided according to whether EVCS 101 comprises electrical connector 112 or not. In some examples, combining adapter 104 and electrical connector 112 can be undesirable due to the resulting decrease in portability of adapter 104. Still, combining adapter 104 and electrical connector 112 can have the effect of reducing costs for the operator of EVCS 101.

When adapter 104 is coupled to EVCS 101, EVCS 101 and adapter 104, in combination, can operate as a smart EVCS that is able to leverage (e.g., in real time) one or more external resources (e.g., ETSN computer system 109, electric grid computer system 110, EMS 111, etc.). Intelligence module 105 is configured to control (e.g., in real time) adapter 104 and/or operations module 106, as described below. Using communication module 108, intelligence module 105 is able to communicate with and employ the one or more external resources (e.g., in real time) in determining the manner in which intelligence module 105 controls adapter 104 and/or operations module 106. Intelligence module 105 can comprise and/or can be implemented as intelligence module computer system 116. In many embodiments, intelligence module 105 can also use communication module 108 to communicate with EVCS computer system 119 when EVCS 101 comprises EVCS computer system 119. In these embodiments, intelligence module 105 can also control and/or operate cooperative with EVCS computer system 119 in order to permit EVCS 101 and adapter 104 to operate in combination as the smart EVCS. Still, in some embodiments, intelligence module 105 can ignore, disable, and/or override EVCS computer system 119.

Communication module 108 is configured to provide communication (e.g., in real time) between (a) intelligence module 105 and/or intelligence module computer system 116 and (b) one or more of EVCS 101, EVRESS 103, adapter 104, operations module 106, interruption mechanism 107, ETSN computer system 109, electric grid computer system 110, EMS 111, user interface 115, EVCS computer system 119, and/or electric vehicle 120. In some embodiments, communication module 108 can also be configured to provide communication (e.g., in real time) between (a) intelligence module 105 and/or intelligence module computer system 116 and (b) first locking mechanism 117 and/or second locking mechanism 118, such as, for example, where first locking mechanism 117 and/or second locking mechanism 118 are electronically operated, as described further below.

Accordingly, communication module 108 can comprise a communication network comprising (a) one or more components configured to provide wired communication (e.g., one or more data buses, such as, for example, universal serial bus(es); one or more networking cables, such as, for example, coaxial cable(s), optical fiber cable(s), twisted pair cable(s); any other suitable data cable, etc.) and/or (b) one or more components configured to provide wireless communication (e.g., one or more radio transceivers, one or more infrared transceivers, etc.) between (i) intelligence module 105 and/or intelligence module computer system 116 and (ii) one or more of EVCS 101, EVRESS 103, adapter 104, operations module 106, interruption mechanism 107, ETSN computer system 109, electric grid computer system 110, EMS 111, user interface 115, first locking mechanism 117, second locking mechanism 118, EVCS computer system 119, and/or electric vehicle 120. Communication module 108 can be configured to operate using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The components forming the communication network of communication module 108 can be dependent on the network topologies and/or protocols in use, and vice versa.

When controlling operations module 106, intelligence module 105 can determine when adapter 104 receives electricity from EVCS 101 and/or when adapter 104 makes electricity available to EVRESS 103 by controlling interruption mechanism 107. In further embodiments, intelligence module can also determine when adapter 104 receives electricity from EVRESS 103 and/or when adapter 104 makes electricity available to electric grid 102 by controlling interruption mechanism 107. To this end, interruption mechanism 107 can be configured to control when adapter 104 receives electricity from EVCS 101, when adapter 104 makes electricity available to EVRESS 103, when adapter 104 receives electricity from EVRESS 103, and/or when adapter 104 makes electricity available to electric grid 102, such as, for example, (1) by selectively interrupting (e.g., in real time) the electric vehicle bus standard communication (e.g., based on control by intelligence module 105) between (a) electrical connector 112 and/or EVCS 101 and (b) electric vehicle 120, EVRESS 103, and/or EMS 111, and/or (2) by manipulating (e.g., in real time) the pilot signal transmitted between EVCS 101 and electric vehicle 120, EVRESS 103, and/or EMS 111 (e.g., based on control by intelligence module 105). Accordingly, interruption mechanism 107 can comprise any suitable electronic circuitry and/or components (e.g., contactors) permitting control of when adapter 104 receives electricity from EVCS 101, when adapter 104 makes electricity available to EVRESS 103, when adapter 104 receives electricity from EVRESS 103, and/or when adapter 104 makes electricity available to electric grid 102, such as, for example, in the manner described above.

Meanwhile, in some embodiments, operations module 106 can also be configured to condition (e.g., in real time) the electricity that adapter 104 makes available to EVRESS 103 and/or electric grid 102, when applicable, as determined by intelligence module 105. Accordingly, operations module 106 can further comprise any suitable electronic circuitry and/or components permitting operations module 106 to condition electricity (e.g., via one or more devices configured to establish, maintain, and/or change electric voltage(s)/electric current(s) of the electricity) being transferred from electric grid 102 to EVRESS 103 (and/or vice versa). Intelligence module 105 can be configured to condition the electricity based on one or more static charging condition(s) and/or one or more dynamic charging condition(s), as described below.

Accordingly, communication module 108 can be configured to interrogate electric vehicle 120, EVRESS 103, and/or EMS 111 to identify static charging condition(s) of EVRESS 103. As part of interrogating electric vehicle 120, EVRESS 103, and/or EMS 111 to identify static charging condition(s) of EVRESS 103, communication module 108 can be configured to determine whether EVRESS 103 comprises EMS 111. Exemplary static charging condition(s) can comprise the nominal charging electric voltage of EVRESS 103, the maximum charging electric current of EVRESS 103, the optimal temperature range for charging EVRESS 103, etc. Meanwhile, communication module 108 can also be configured to interrogate (e.g., periodically) electric vehicle 120, EVRESS 103, and/or EMS 111 to identify one or more dynamic charging conditions of EVRESS 103 when communication module 108 communicates with electric vehicle 120, EVRESS 103, and/or EMS 111 and/or when adapter 104 is making electricity available to EVRESS 103. Exemplary dynamic charging conditions can comprise a measured and/or calculated internal temperature of EVRESS 103, a measured and/or calculated internal pressure of EVRESS 103, a measured and/or calculated internal resistance free electric voltage of EVRESS 103, a state of charge of EVRESS 103, a state of health of EVRESS 103, a measured and/or calculated electric current at EVRESS 103, a measured and/or calculated electric voltage at EVRESS 103, etc.

Internal resistance free electric voltage can refer to an electric voltage of EVRESS 103 when EVRESS 103 is neither receiving electricity from adapter 104 nor providing electricity to electric vehicle 120. Accordingly, interruption mechanism 107 can be configured to interrupt (e.g., periodically), as appropriate, when adapter 104 receives electricity from electric grid 102 and/or makes electricity available to EVRESS 103 (e.g., as controlled by intelligence module 105) so that EVRESS 103 is not receiving electricity from adapter 104. This interrupt can be configured to approximately coincide in time with when communication module 108 interrogates electric vehicle 120, EVRESS 103, and/or EMS 111 regarding the dynamic charging condition of the internal resistance free electric voltage of EVRESS 103. In these examples, EVRESS 103 can also not be providing electricity to electric vehicle 120.

The interval at which communication module 108 interrogates electric vehicle 120 and/or at which interruption mechanism 107 interrupts when adapter 104 receives electricity from electric grid 102 and/or makes electricity available to EVRESS 103 can occur at one or more predetermined time intervals. Thus, the static charging condition(s) can also comprise the predetermined time interval(s), and/or the predetermined time interval(s) can be established by intelligence module 105. Furthermore, in many embodiments, where one or more of the dynamic charging conditions require calculation, some or all of the dynamic charging conditions can be calculated by EMS 111, and/or some or all of the dynamic charging conditions can be calculated by intelligence module 105. In these embodiments, electric vehicle 120 and/or EMS 111 can measure one or more variables (e.g., electric voltage at EVRESS 103, electric current at EVRESS 103, internal temperature of EVRESS 103, internal pressure of EVRESS 103, internal resistance of EVRESS 103, etc.) by which EMS 111 and/or intelligence module 105 can calculate the dynamic charging condition(s).

Meanwhile, communication module 108 can also be configured to gather electric vehicle data and/or electric vehicle rechargeable energy storage system (EVRESS) data when communication module 108 communicates with electric vehicle 120, EVRESS 103, and/or EMS 111. Communication module 108 can be configured to provide the electric vehicle data and/or the EVRESS data to ETSN computer system 109, such as, for example, for aggregation and storage in one or more computer databases (e.g., XML (Extensible Markup Language) database(s), MySQL database(s), and/or Oracle® database(s)) of ETSN computer system 109, as mentioned previously with respect to the description of the electricity transfer system network. The electric vehicle data and/or the EVRESS data can further be indexed as a searchable group of individual data files stored in one or more memory storage modules of ETSN computer system 109 such that the electric vehicle data and/or the EVRESS data can be retrieved by users via their user profiles and/or by intelligence module 105. Exemplary electric vehicle data can comprise maintenance requirements for electric vehicle 120, locations of electric vehicle 120 (e.g., provided by a global positioning system of electric vehicle 120), etc. Meanwhile, exemplary EVRESS data can comprise any of the dynamic charging condition(s).

In many embodiments, intelligence module 105 can determine the manner in which to control adapter 104, operations module 106, and/or interruption mechanism 107 based solely on communication with electric vehicle 120, EVRESS 103, and/or EMS 111. However, in further embodiments, intelligence module 105 can further control the manner in which to control adapter 104, operations module 106, and/or interruption mechanism 107 based on communication with additional external resources (e.g., ETSN computer system 109, electric grid computer system 110, etc.).

For example, in determining the manner in which to control adapter 104, operations module 106, and/or interruption mechanism 107, intelligence module 105 can consider electric utility data provided by electric grid computer system 110. Electric utility data can comprise energy demand on electric grid 102, requests by the operator of electric grid 102 for ancillary services and/or electricity demand reduction on electric grid 102, availability of alternative energy resources of electric grid 102 (e.g., solar, wind, tidal, nuclear, etc.), etc. The energy demand on electric grid 102 can also permit intelligence module 105 to control adapter 104, operations module 106, and/or interruption mechanism 107 to provide energy shifting to off-peak times/days. Meanwhile, in determining the manner in which to control adapter 104, operations module 106, and/or interruption mechanism 107, intelligence module 105 can consider electric vehicle data and/or EVRESS data provided by ETSN computer system 109, as described above. ETSN computer system 109 can also provide the energy contract rates for users which intelligence module 105 can also factor in its control determination.

Furthermore, in determining the manner in which to control adapter 104, operations module 106, and/or interruption mechanism 107, intelligence module 105 can consider charge request data provided by users of ETS 100 via user interface 115 and/or their personal computing device (e.g., a desktop computer system, a laptop computer system, and/or any suitable mobile electronic computer system, such as, for example, a tablet computer system, and/or a smart phone, etc.). Exemplary charge request data can comprise a requested manner in which to charge EVRESS 103 and/or a requested time and day during which to charge EVRESS 103. In more specific examples, charge request data can comprise a requested state of charge up to which EVRESS 103 is to be charged, a quantity of electricity to provide to EVRESS 103 based on the quantity and/or a cost of the quantity, a distance a user needs to travel, a time by which to complete a charge of EVRESS 103, an energy cost ceiling above which not to charge EVRESS 103, one or more reservations for EVCS 101, etc.

Communication module 108 can also be configured to gather charge request data and to provide the electric grid data and/or charge request data to ETSN computer system 109, such as, for example, for aggregation and storage in the computer database(s) (e.g., XML (Extensible Markup Language) database(s), MySQL database(s), and/or Oracle® database(s)) of ETSN computer system 109.

Further still, (a) International Patent Application Serial No. PCT/US2011/034667, filed Apr. 29, 2011; (b) International Patent Application Serial No. PCT/US2011/037587, filed May 23, 2011; (c) International Patent Application Serial No. PCT/US2011/037588, filed May 23, 2011; and (d) International Patent Application Serial No. PCT/US2011/037590, filed May 23, 2011 each further detail manners in which intelligence module 105 can control adapter 104, operations module 106, and/or interruption mechanism 107 while leveraging external resources. Accordingly, the disclosures for each of (a) International Patent Application Serial No. PCT/US2011/034667, (b) International Patent Application Serial No. PCT/US2011/037587, (c) International Patent Application Serial No. PCT/US2011/037588, and (d) International Patent Application Serial No. PCT/US2011/037590 are incorporated herein by reference.

In many embodiments, adapter 104 and/or operations module 106 can be configured to operate as determined by intelligence module 105 even when intelligence module 105 is located remotely from adapter 104 and/or operations module 106. In these embodiments, adapter 104 and/or operations module 106 can (a) continue being controlled wirelessly (e.g., via communication module 108) by intelligence module 105 and/or (b) operate according to the last received commands provided by intelligence module 105.

In some embodiments, intelligence module 105 can comprise a personal computing device (e.g., a desktop computer system, a laptop computer system, and/or any suitable mobile electronic computer system, such as, for example, a tablet computer system, and/or a smart phone, etc.) of a user of ETS 100. In these embodiments, the user of ETS 100 can download and install application software on her personal computing device permitting the user to operate ETS 100 and/or to configured her personal computing device as intelligence module 105. Accordingly, in these embodiments, intelligence module 105 can be more likely to control adapter 104, operations module 106, and/or interruption mechanism 107 remotely for at least part of the time that adapter 104 makes electricity available to EVRESS 103.

Beyond controlling adapter 104, operations module 106, and/or interruption mechanism 107, intelligence module 105 can also (a) provide advertisements, public service announcements, etc. to users of ETS 100 (e.g., via user interface 115), (b) provide notifications (e.g., charge status, charge interruption, etc.) to users of ETS 100 at user interface 115, and/or (c) operate as a home energy management system for users of ETS 100, such as, for example, to control one or more home electronic appliances. When intelligence module 105 operates as a home energy management system, users can operate the home energy management system locally via user interface 115 of intelligence module 105 of ETS 100 and/or remotely via their personal computing device (e.g., wired and/or wireless communication network enabled television, a desktop computer system, a laptop computer system, and/or any suitable mobile electronic computer system, such as, for example, a tablet computer system, and/or a smart phone, etc.). In these embodiments, the home energy management system can operate cooperatively with and/or independently from EVCS 101. Meanwhile, intelligence module 105 can also provide users of ETS 100 with (a) internet browsing capability and (b) mapping and directions to EVCS('s) (e.g., EVCS 101), (c) reservation services for reserving those EVCS('s), and/or (d) availability of those EVCS('s). Further still, intelligence module 105 can also administrate payment for use of EVCS 101, such as, for example, through communication with ETSN computer system 110 (e.g., via communication module 108) and by referencing the electricity meter, as described below, of ETS 100. For many examples, communication module 108 can also provide communication with any additional devices (e.g., personal computing devices, third-party computer systems (e.g., bank computer systems, internet provider computer systems, etc.), as applicable, to provide these functionalities.

When adapter 104 is coupled to EVCS 101, first locking mechanism 113 can prevent adapter 104 from being decoupled from EVCS 101. First locking mechanism 113 can comprise any mechanical, electronic, or other suitable device for locking adapter 104 to EVCS 101, electrical connector 112, and/or the electrical cable coupling electrical connector 112 to EVCS 101, as applicable. First locking mechanism 113 can be configured to lock mechanically (e.g., by a key, by a combination, etc.) and/or electronically via intelligence module 105 and/or user interface 115 (e.g., by a code/password, etc.). In some embodiments, first locking mechanism 113 can be omitted.

When adapter 104 is coupled to EVRESS 103, second locking mechanism 114 can prevent adapter 104 from being decoupled from EVRESS 103. Second locking mechanism 114 can comprise any mechanical, electronic, or other suitable device for locking adapter 104 to EVRESS 103. Second locking mechanism 114 can be similar or identical to first locking mechanism 113. In some embodiments, second locking mechanism 114 can be omitted. First locking mechanism 113 and/or second locking mechanism 114 can prevent adapter 104 and/or electricity from being stolen. In some embodiments, first locking mechanism 113 and second locking mechanism 114 operate independently of each other while in other embodiments, first locking mechanism 113 and second locking mechanism 114 operate reciprocally with each other.

User interface 115 can be configured to operate adapter 104, intelligence module 105, operations module 106, and/or communications module 108. Likewise, user interface 115 can permit users of ETS 100 to access their user profiles, manage their user accounts, and/or permit users to use ETS 100 to charge the EVRESS (e.g., EVRESS 103) of their electric vehicle (e.g., electric vehicle 120). Likewise, users of ETS 100 can provide payment (e.g., via charge card, credit card, debit card, cash, an e-commerce provider such as PayPal of San Jose, Calif., etc.) for using ETS 100 via user interface 115 and/or via their personal computing device (e.g., a desktop computer system, a laptop computer system, and/or any suitable mobile electronic computer system, such as, for example, a tablet computer system, and/or a smart phone, etc.). Users of ETS 100 can also manually enter static charging condition(s) of EVRESS 103, such as, for example, where EVRESS 103 does not comprise EMS 111 or where EMS 111 is not configured to calculate and/or store static charging condition(s). Users of ETS 100 can also manually enter charge request data via user interface 115.

User interface 115 can comprise any suitable combination of interactive and/or passive input/output mechanisms (e.g., one or more electronic displays, such as, for example, (color and/or black and white) touch screen electronic display(s), one or more keyboards, one or more keypads, one or more speakers, one or more magnetic stripe card readers, one or more radio frequency identification (RFID) transceivers, etc.) configured to permit users to access their user profiles, manage their user accounts, and/or to operate ETS 100. Accordingly, in applicable embodiments, users can manually enter static charging condition(s) passively, such as, for example, by interfacing a magnetic stripe card with the magnetic stripe reader or interfacing a RFID device (e.g., a fob) with the RFID transceiver where the magnetic stripe card and/or the RFID device are programmed with the static charging condition(s). In other embodiments, users can manually enter static charging condition(s) interactively, such as, for example, via touch screen electronic display(s), the keyboard(s), the keypad(s), etc.

In many embodiments, the interactive and/or passive input/output mechanisms can comprise one or more dedicated buttons configured to display the state of charge of EVRESS 103, configured to engage communication module 108, and/or configured to cause adapter 104 to undergo an emergency shutoff Likewise, the interactive and/or passive input/output mechanisms can comprise one or more dedicated buttons for activating first locking mechanism 113 and/or second locking mechanism 114.

ETS 100 (and EVCS 103) can comprise an electricity meter to meter electricity provided to EVRESS 103 by EVCS 102 and/or adapter 104 as well as to electric grid 102 by adapter 104. Meanwhile, ETS 100 (and EVCS 103) can comprise interlock provisions to prevent theft of electricity, etc. The interlock provisions can comprise first locking mechanism 113 and/or second locking mechanism 114.

Adapter 104 and/or intelligence module 105 can be internally (e.g., by one or more single-use and/or rechargeable energy storage systems (e.g., one or more batteries)) and/or externally electrically powered (e.g., through coupling with an external energy source, such as, for example, electric grid 102, EVCS 101, EVRESS 103, and/or any electrical receptacle (e.g., any National Electrical Manufacturers Association (NEMA) electrical receptacle). When integrated and/or coupled together, adapter 104 and/or intelligence module 105 can be electrically powered by the same energy source while, when separate, adapter 104 and intelligence module 105 can be electrically powered by separate energy sources. For example, adapter 104 can be configured to siphon a portion of electricity from EVCS 101 to electrically power adapter 104 and/or intelligence module 105 while making available a remainder of the electricity to EVRESS 103; meanwhile, intelligence module 105 can comprise an internal intelligence module rechargeable energy storage system configured to electrically power intelligence module 105, at least when adapter 104 is decoupled from EVCS 101.

ETS 100 can be configured so as to require minimal or no installation beyond coupling adapter 104 to EVCS 101 and EVRESS 103. In this manner, ETS 100 can be referred to as a “plug-and-play” system. Meanwhile, because ETSNs frequently require users to authenticate their identity (e.g., via RFID, via credit card, via entry of user name and password, etc.), ETS 100 can simplify this process by permitting authentication merely by using one's personal adapter 104. Accordingly, ETS 100 can be configured to be associable with its user to permit such identification and authentication.

Some or all of ETS 100 can be sold as an after market product and/or electric vehicle accessory by electric vehicle dealerships. Selling ETS 100 (e.g., adapter 104, intelligence module 105, and communication module 108) can be substantially less expensive than selling a fully integrated EVCS having smart EVCS functionality.

ETS 100 can permit ETSN operators to remove themselves from or limit their involvement in manufacturing EVCS's (e.g., EVCS 101) because ETS 100 can permit smart EVCS functionality without those ETSN operators having to take active part in manufacturing the EVCS's (e.g., limiting those ETSN operators to manufacturing and/or commissioning manufacturing of ETS 100). As a result, ETSN operators can focus on developing and/or delivering services through their respective operating systems rather than having to also spend time, energy, and resources on developing and/or providing EVCS hardware.

Likewise, ETS 100 can shift costs of implementing ETS 100 from the ETSN operator(s) to the host(s) (e.g., owner, leasor, and/or leasee) of the EVCS('s) (e.g., EVCS 101) where the ETSN operator(s) are not hosting the EVCS('s). Accordingly, the ETSN operator(s) can derive revenue from membership fees, as described above, from annual services and maintenance fees for software updates, from advertising, from access fees to use the EVCS('s) (e.g., EVCS 101) where the ETSN operator(s) are also the host(s), from demand reduction for electric grid 102, from transaction fees for remote and/or credit card based payments, and when applicable, from administrating ancillary services to electric grid 102, etc. Meanwhile, the ETSN operator(s) can also share revenue with each other, with users of ETS 100, and/or with the host(s) of the EVCS('s) (e.g., EVCS 101), as applicable, and/or with original equipment manufacturers of the EVCS('s), such as, for example, to incentivize original equipment manufacturers to manufacture EVCS's compatible with ETS 100 and/or to sell ETS 100.

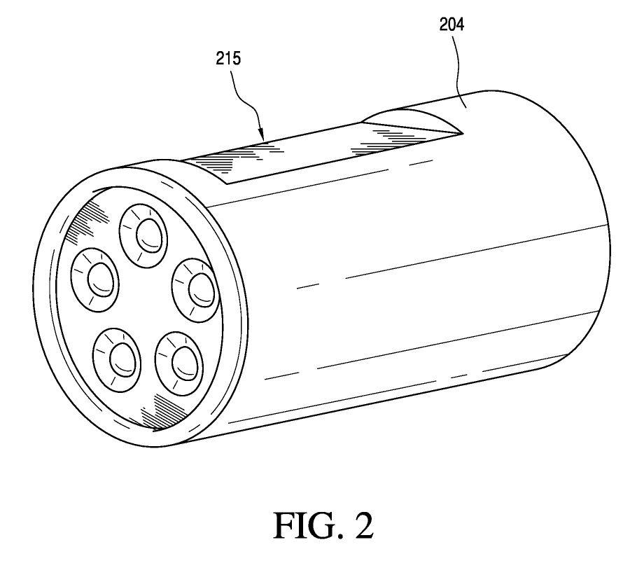

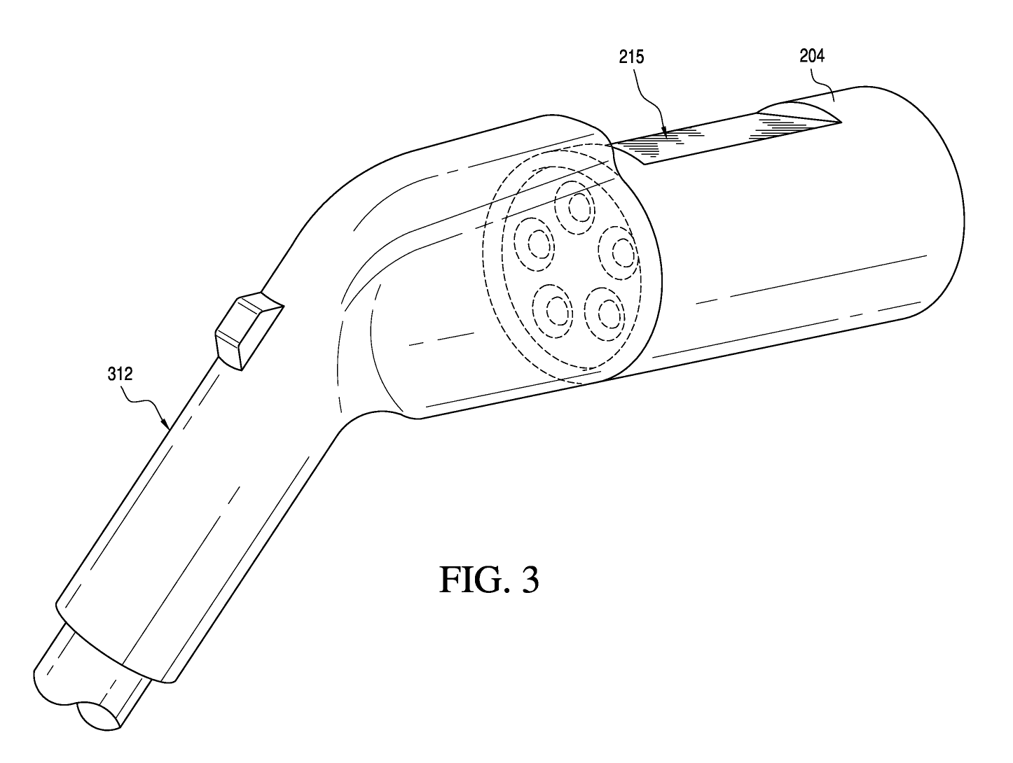

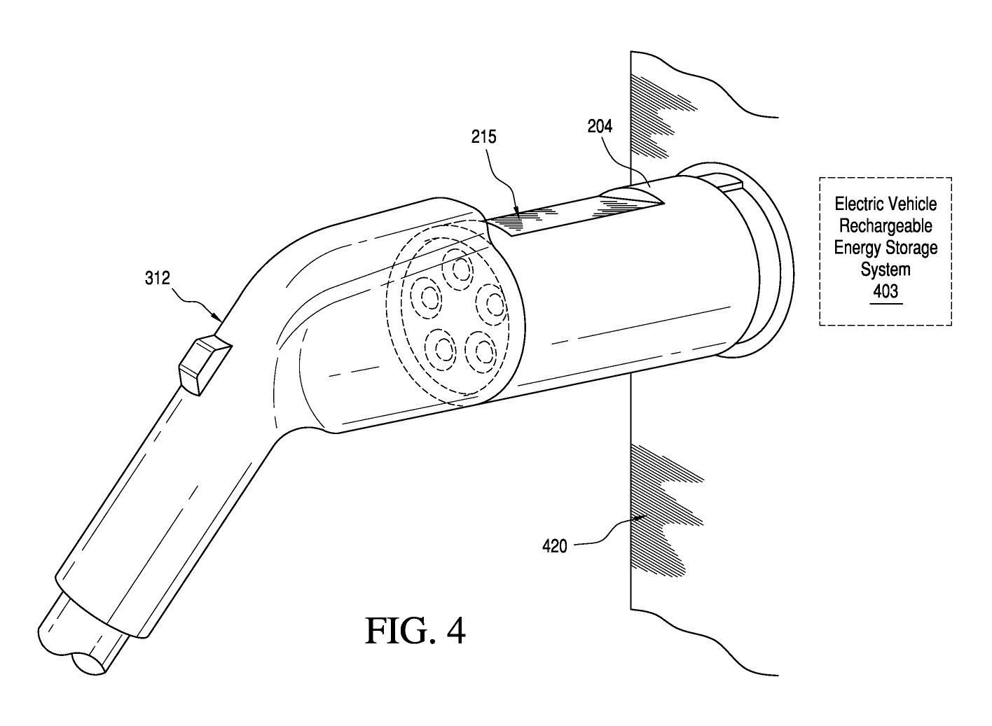

FIG. 2 illustrates an exemplary adapter 204 comprising integrated user interface 215, according to the embodiment of FIG. 1. Adapter 204 can be similar or identical to adapter 104 (FIG. 1), and user interface 215 can be similar or identical to user interface 115 (FIG. 1). Meanwhile, FIG. 3 illustrates adapter 204 coupled to an exemplary electrical connector 312, according to the embodiment of FIG. 1. Electrical connector 312 can be similar or identical to electrical connector 112 (FIG. 1). Further still, FIG. 4 illustrates adapter 204 coupled to electrical connector 312 and to an exemplary electric vehicle rechargeable energy storage system (EVRESS) 403 of electric vehicle 420, according to the embodiment of FIG. 1. EVRESS 403 can be similar or identical to EVRESS 103, and electric vehicle 420 can be similar or identical to electric vehicle 120 (FIG. 1).

FIG. 5 illustrates another exemplary adapter 504 comprising electrical connector 512, according to the embodiment of FIG. 1. Adapter 504 can be similar or identical to adapter 104 (FIG. 1), and electrical connector 512 can be similar or identical to electrical connector 112 (FIG. 1).

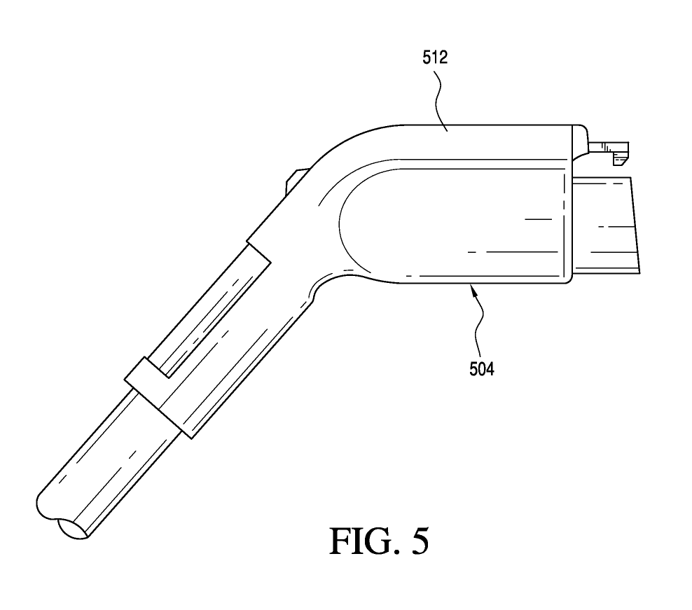

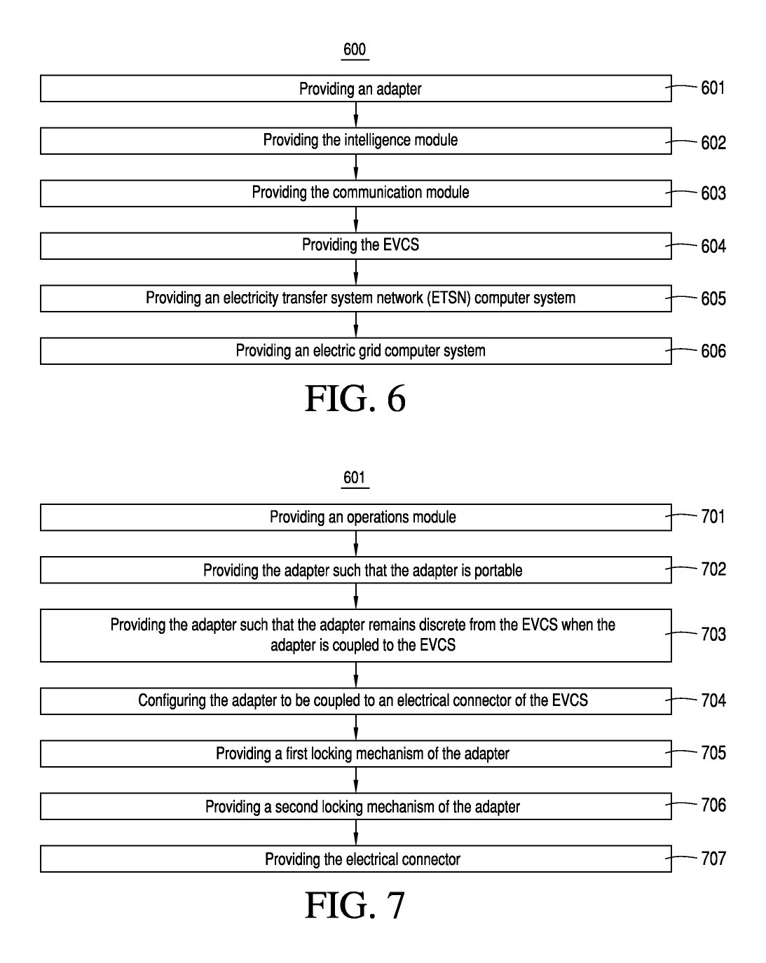

In FIGS. 2-4, adapter 204 is separate from electrical connector 312, but in FIG. 5, adapter 504 can be integral with electrical connector 512. FIG. 6 illustrates a flow chart for an embodiment of method 600 of providing an electricity transfer system (ETS) for modifying an electric vehicle charging station (EVCS). Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any other suitable order. In still other embodiments, one or more of the procedures, the processes, and/or the activities in method 600 can be combined or skipped. The ETS can be similar or identical to ETS 100 (FIG. 1), and the EVCS can be similar or identical to EVCS 101 (FIG. 1).

Method 600 comprises procedure 601 of providing an adapter. The adapter can be similar or identical to adapter 104 (FIG. 1), adapter 204 (FIG. 2), and/or adapter 504 (FIG. 5). FIG. 7 illustrates an exemplary procedure 601.

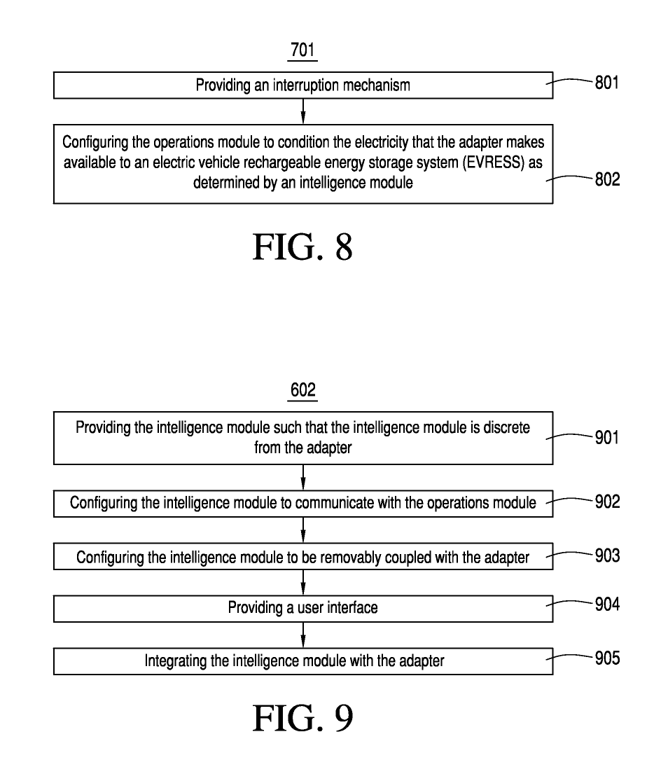

Referring to FIG. 7, procedure 601 can comprise process 701 of providing an operations module. The operations module can be similar or identical to operations module 106 (FIG. 1). FIG. 8 illustrates an exemplary process 701.

Referring to FIG. 8, process 701 can comprise activity 801 of providing an interruption mechanism. The interruption mechanism can be similar or identical to interruption mechanism 107 (FIG. 1).

Process 701 can comprise activity 802 of configuring the operations module to condition the electricity that the adapter makes available to an electric vehicle rechargeable energy storage system (EVRESS) as determined by an intelligence module. The EVRESS can be similar or identical to EVRESS 103 (FIG. 1) and/or EVRESS 403 (FIG. 4), and the intelligence module can be similar or identical to intelligence module 105 (FIG. 1). Accordingly, in many embodiments, performing activity 802 can comprise configuring the operations module to condition the electricity that the adapter makes available to the electric vehicle rechargeable energy storage system as determined by an intelligence module in a manner similar or identical to that described above with respect to ETS 100 (FIG. 1).

Returning now to FIG. 7, procedure 601 can comprise (a) process 702 of providing the adapter such that the adapter is portable, and/or (b) process 703 of providing the adapter such that the adapter remains discrete from the EVCS when the adapter is coupled to the EVCS. In some embodiments, process 702 and/or process 703 can be omitted; their sequence can be reversed; or they can occur simultaneously with each other.

Procedure 601 can comprise process 704 of configuring the adapter to be coupled to an electrical connector of the EVCS. The electrical connector can be similar or identical to electrical connector 112 (FIG. 1), electrical connector 312 (FIG. 3), and/or electrical connector 512 (FIG. 5).

Procedure 601 can comprise process 705 of providing a first locking mechanism of the adapter. The first locking mechanism can be similar or identical to first locking mechanism 113 (FIG. 1). In some embodiments, process 705 can be omitted.

Procedure 601 can comprise process 706 of providing a second locking mechanism of the adapter. The second locking mechanism can be similar or identical to second locking mechanism 114 (FIG. 1). In some embodiments, process 706 can be omitted.

Procedure 601 can comprise process 707 of providing the electrical connector. In some embodiments, process 707 can be omitted.

Returning now to FIG. 6, method 600 also comprises procedure 602 of providing the intelligence module. FIG. 9 illustrates an exemplary procedure 602.

Referring to FIG. 9, procedure 602 can comprise process 901 of providing the intelligence module such that the intelligence module is discrete from the adapter. In many embodiments, performing process 901 can comprise providing the intelligence module such that the intelligence module is discrete from the adapter in a manner similar or identical to that described above with respect to ETS 100 (FIG. 1). In some embodiments, process 901 can be omitted.

Procedure 602 can comprise process 902 of configuring the intelligence module to communicate with the operations module, such as, for example, via a communication module. The communication module can be similar or identical to communication module 108 (FIG. 1).

Procedure 602 can comprise process 903 of configuring the intelligence module to be removably coupled with the adapter. In some embodiments, process 903 can be omitted.

Procedure 602 can comprise process 904 of providing a user interface. The user interface can be similar or identical to user interface 115 (FIG. 1). In some embodiments, process 904 can be omitted or can be part of a different procedure.

Meanwhile, in many embodiments, procedure 602 (FIG. 6) can be performed as part of procedure 601 (FIG. 6). In these embodiments, procedure 602 can comprise process 905 of integrating the intelligence module with the adapter. In other embodiments, process 905 can be omitted.

Returning again to FIG. 6, method 600 also comprises procedure 603 of providing the communication module. Meanwhile, in some embodiments, method 600 can comprise procedure 604 of providing the EVCS; method 600 can comprise procedure 605 of providing an electricity transfer system network (ETSN) computer system; and/or method 600 can comprise procedure 606 of providing an electric grid computer system. The ETSN computer system can be similar or identical to ETSN computer system 109 (FIG. 1), and the electric grid computer system can be similar or identical to electric grid computer system 110 (FIG. 1). The sequence of procedures 601-606 can be performed in any order.

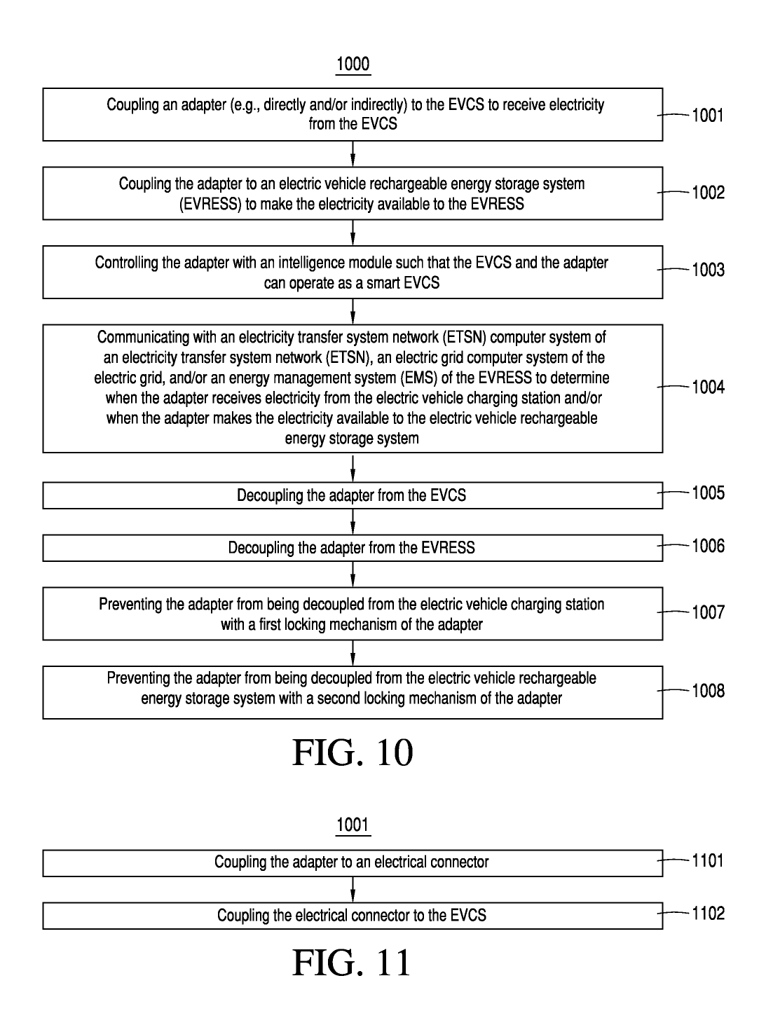

Returning again to the drawings, FIG. 10 illustrates a flow chart for an embodiment of method 1000 for modifying an electric vehicle charging station (EVCS). Method 1000 is merely exemplary and is not limited to the embodiments presented herein. Method 1000 can be employed in many different embodiments or examples not specifically depicted or described herein. In some embodiments, the procedures, the processes, and/or the activities of method 1000 can be performed in the order presented. In other embodiments, the procedures, the processes, and/or the activities of method 1000 can be performed in any other suitable order. In still other embodiments, one or more of the procedures, the processes, and/or the activities in method 1000 can be combined or skipped. The EVCS can be similar or identical to EVCS 101 (FIG. 1).

Method 1000 comprises procedure 1001 of coupling an adapter (e.g., directly and/or indirectly) to the EVCS to receive electricity from the EVCS. The adapter can be similar or identical to adapter 104 (FIG. 1), adapter 204 (FIG. 2), and/or adapter 504 (FIG. 5). In many embodiments, performing procedure 1001 can comprise coupling the adapter (e.g., directly and/or indirectly) to the EVCS to receive electricity from the EVCS in a manner similar or identical to that described above with respect to ETS 100 (FIG. 1). FIG. 11 illustrates an exemplary procedure 1001.

Referring to FIG. 11, procedure 1001 can comprise process 1101 of coupling the adapter to an electrical connector. The electrical connector can be similar or identical to electrical connector 112 (FIG. 1), electrical connector 312 (FIG. 3) and/or electrical connector 512 (FIG. 5).

Procedure 1002 can comprise process 1102 of coupling the electrical connector to the EVCS. In some embodiments, process 1101, process 1102, and/or procedure 1001 can be omitted.

Returning to FIG. 10, method 1000 comprises procedure 1002 of coupling the adapter to an electric vehicle rechargeable energy storage system (EVRESS) to make the electricity available to the EVRESS. The EVRESS can be similar or identical to EVRESS 103 (FIG. 1) and/or EVRESS 403 (FIG. 4).

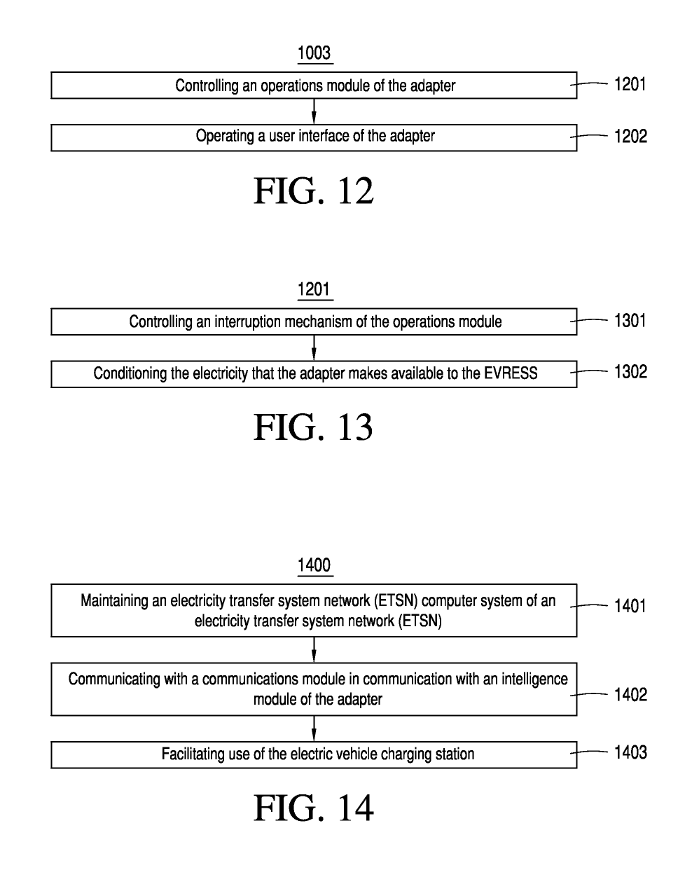

Method 1000 comprises procedure 1003 of controlling the adapter with an intelligence module such that the EVCS and the adapter can operate as a smart EVCS. In many embodiments, procedure 1003 is performed after performing procedure 1001 and/or procedure 1002. FIG. 12 illustrates an exemplary procedure 1003. The intelligence module can be similar or identical to intelligence module 105 (FIG. 1). The smart EVCS can be similar or identical to the smart EVCS described above with respect to ETS 100 (FIG. 1).

Referring to FIG. 12, procedure 1003 can comprise process 1201 of controlling an operations module of the adapter. The operations module can be similar or identical to operations module 106 (FIG. 1). FIG. 13 illustrates an exemplary process 1201.

Referring to FIG. 13, process 1201 can comprise activity 1301 of controlling an interruption mechanism of the operations module. The interruption mechanism can be similar or identical to interruption mechanism 107 (FIG. 1).

Process 1201 can comprise activity 1302 of conditioning the electricity that the adapter makes available to the EVRESS. In many embodiments, performing activity 1302 can comprise conditioning the electricity that the adapter makes available to the EVRESS in a manner similar or identical to that described above with respect to ETS 100 (FIG. 1) and operations module 106 (FIG. 1).

Referring back to FIG. 12, procedure 1003 can comprise process 1202 of operating a user interface of the adapter. The user interface can be similar or identical to user interface 115 (FIG. 1) and/or user interface 215 (FIG. 2).

Returning to FIG. 10, method 1000 can comprise procedure 1004 of communicating with an electricity transfer system network (ETSN) computer system of an electricity transfer system network (ETSN), an electric grid computer system of the electric grid, and/or an energy management system (EMS) of the EVRESS to determine when the adapter receives electricity from the electric vehicle charging station and/or when the adapter makes the electricity available to the electric vehicle rechargeable energy storage system. In other embodiments, procedure 1004 can determine when the adapter receives electricity from the electric vehicle rechargeable energy storage system and/or when the adapter makes the electricity available to the electric vehicle charging station. The ETSN computer system can be similar or identical to ETSN computer system 109 (FIG. 1); the electric grid computer system can be similar or identical to electric grid computer system 110 (FIG. 1); and/or the EMS can be similar or identical to EMS 111 (FIG. 1). Meanwhile, ETSN can be similar to the ETSN described above with respect to ETS 100 (FIG. 1), and the electric grid can be similar or identical to electric grid 102 (FIG. 1).

Method 1000 can comprise procedure 1005 of decoupling the adapter from the EVCS; and/or procedure 1006 of decoupling the adapter from the EVRESS.

Method 1000 can comprise procedure 1007 of preventing the adapter from being decoupled from the electric vehicle charging station with a first locking mechanism of the adapter. The first locking mechanism can be similar or identical to first locking mechanism 113 (FIG. 1).

Method 1000 can comprise procedure 1008 of preventing the adapter from being decoupled from the electric vehicle rechargeable energy storage system with a second locking mechanism of the adapter. The second locking mechanism can be similar or identical to second locking mechanism 114 (FIG. 1). One or more of procedures 1007 and 1008 can occur before one or more of procedures 1005 and 1006.

Returning again to the drawings, FIG. 14 illustrates a flow chart for an embodiment of method 1400 of supporting an adapter for modifying an electric vehicle charging station (EVCS) such that the EVCS and the adapter operate as a smart EVCS. Method 1400 is merely exemplary and is not limited to the embodiments presented herein. Method 1400 can be employed in many different embodiments or examples not specifically depicted or described herein. In some embodiments, the procedures, the processes, and/or the activities of method 1400 can be performed in the order presented. In other embodiments, the procedures, the processes, and/or the activities of method 1400 can be performed in any other suitable order. In still other embodiments, one or more of the procedures, the processes, and/or the activities in method 1400 can be combined or skipped. The adapter can be similar or identical to adapter 104 (FIG. 1), adapter 204 (FIG. 2), and/or adapter 504 (FIG. 5); the EVCS can be similar or identical to EVCS 101 (FIG. 1); and the smart EVCS can be similar or identical to the smart EVCS described above with respect to ETS 100 (FIG. 1).

Method 1400 comprises procedure 1401 of maintaining an electricity transfer system network (ETSN) computer system of an electricity transfer system network (ETSN). The ETSN computer system can be similar or identical to ETSN computer system 109 (FIG. 1). The ETSN can be similar or identical to the ETSN described above with respect to ETS 100 (FIG. 1).

Method 1400 comprises procedure 1402 of communicating with a communications module in communication with an intelligence module of the adapter. The communications module can be similar or identical to communications module 108 (FIG. 1), and the intelligence module can be similar or identical to intelligence module 105 (FIG. 1).

Method 1400 can comprise procedure 1403 of facilitating use of the electric vehicle charging station. In these embodiments, the electricity transfer system network can comprise the electric vehicle charging station.

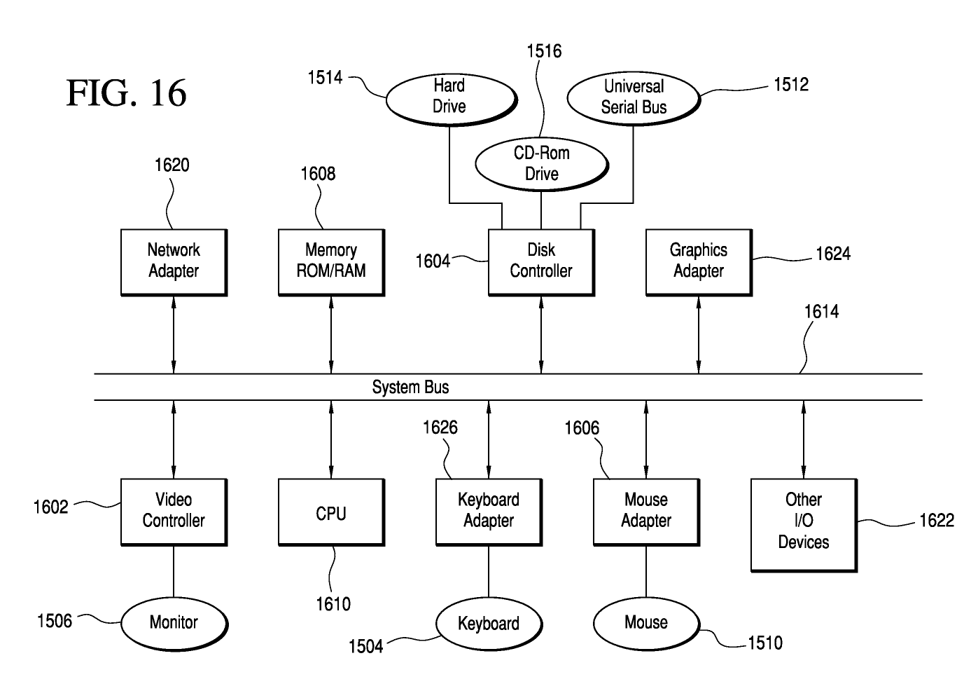

Turning again to the next drawing, FIG. 15 illustrates an exemplary embodiment of computer system 1500, all of which or a portion of which can be suitable for implementing an embodiment of intelligence module 105 (FIG. 1), intelligence module computer system 116 (FIG. 1), ETSN computer system 109 (FIG. 1), electric grid computer system 110 (FIG. 1), EMS 111 (FIG. 1), EVCS computer system 119 (FIG. 1), the OEM network computer system, and/or any of various other elements of ETS 100 (FIG. 1) as well as any of the various procedures, processes, and/or activities of method 1000 (FIG. 10) and/or method 1400 (FIG. 14). As an example, a different or separate one of chassis 1502 (and its internal components) can be suitable for implementing intelligence module 105 (FIG. 1), intelligence module computer system 116 (FIG. 1), ETSN computer system 109 (FIG. 1), electric grid computer system 110 (FIG. 1), EMS 111 (FIG. 1), EVCS computer system 119 (FIG. 1), the OEM network computer system, etc. Furthermore, one or more elements of computer system 1500 (e.g., refreshing monitor 1506, keyboard 1504, and/or mouse 1510, etc.) can also be appropriate for implementing ETSN computer system 109 (FIG. 1), electric grid computer system 110 (FIG. 1), and/or the OEM network computer system. Computer system 1500 comprises chassis 1502 containing one or more circuit boards (not shown), Universal Serial Bus (USB) 1512, Compact Disc Read-Only Memory (CD-ROM) and/or Digital Video Disc (DVD) drive 1516, and hard drive 1514. A representative block diagram of the elements included on the circuit boards inside chassis 1502 is shown in FIG. 16. Central processing unit (CPU) 1610 in FIG. 16 is coupled to system bus 1614 in FIG. 16. In various embodiments, the architecture of CPU 1610 can be compliant with any of a variety of commercially distributed architecture families.

Turning to FIG. 16, system bus 1614 also is coupled to memory storage unit 1608, where memory storage unit 1608 comprises both read only memory (ROM) and random access memory (RAM). Non-volatile portions of memory storage unit 1608 or the ROM can be encoded with a boot code sequence suitable for restoring computer system 1500 (FIG. 15) to a functional state after a system reset. In addition, memory storage unit 1608 can comprise microcode such as a Basic Input-Output System (BIOS). In some examples, the one or more memory storage units of the various embodiments disclosed herein can comprise memory storage unit 1608, a USB-equipped electronic device, such as, an external memory storage unit (not shown) coupled to universal serial bus (USB) 1512 (FIGS. 15-16), hard drive 1514 (FIGS. 15-16), and/or CD-ROM or DVD drive 1516 (FIGS. 15-16). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 1610.

In the depicted embodiment of FIG. 16, various I/O devices such as disk controller 1604, graphics adapter 1624, video controller 1602, keyboard adapter 1626, mouse adapter 1606, network adapter 1620, and other I/O devices 1622 can be coupled to system bus 1614. Keyboard adapter 1626 and mouse adapter 1606 are coupled to keyboard 1504 (FIGS. 15-16) and mouse 1510 (FIGS. 15-16), respectively, of computer system 1500 (FIG. 15). While graphics adapter 1624 and video controller 1602 are indicated as distinct units in FIG. 16, video controller 1602 can be integrated into graphics adapter 1624, or vice versa in other embodiments. Video controller 1602 is suitable for refreshing monitor 1506 (FIGS. 15-16) to display images on a screen 1508 (FIG. 15) of computer system 1500 (FIG. 15). Disk controller 1604 can control hard drive 1514 (FIGS. 15-16), USB 1512 (FIGS. 15-16), and CD-ROM drive 1516 (FIGS. 15-16). In other embodiments, distinct units can be used to control each of these devices separately.

In some embodiments, network adapter 1620 can comprise and/or be implemented as a WNIC (wireless network interface controller) card (not shown) plugged or coupled to an expansion port (not shown) in computer system 1500 (FIG. 15). In other embodiments, the WNIC card can be a wireless network card built into computer system 1500 (FIG. 15). A wireless network adapter can be built into computer system 1500 by having wireless communication capabilities integrated into the motherboard chipset (not shown), or implemented via one or more dedicated wireless communication chips (not shown), connected through a PCI (peripheral component interconnector) or a PCI express bus of computer system 1500 (FIG. 15) or USB 1512 (FIG. 15). In other embodiments, network adapter 1620 can comprise and/or be implemented as a wired network interface controller card (not shown). Accordingly, communications module 108 (FIG. 1) can comprise a network adapter similar or identical to network adapter 1620.

Although many other components of computer system 1500 (FIG. 15) are not shown, such components and their interconnection are well known to those of ordinary skill in the art. Accordingly, further details concerning the construction and composition of computer system 1500 and the circuit boards inside chassis 1502 (FIG. 15) are not discussed herein.

When computer system 1500 in FIG. 15 is running, program instructions stored on a USB-equipped electronic device connected to USB 1512, on a CD-ROM or DVD in CD-ROM and/or DVD drive 1516, on hard drive 1514, or in memory storage unit 1608 (FIG. 16) are executed by CPU 1610 (FIG. 16). A portion of the program instructions, stored on these devices, can be suitable for carrying out at least part of ETS 100 (FIG. 1) as well as any of the various procedures, processes, and/or activities of method 1000 (FIG. 10) and/or method 1400 (FIG. 14).

Although computer system 1500 is illustrated as a desktop computer in FIG. 15, there can be examples where computer system 1500 may take a different form factor while still having functional elements similar to those described for computer system 1500. In some embodiments, computer system 1500 may comprise a single computer, a single server, or a cluster or collection of computers or servers, or a cloud of computers or servers. Typically, a cluster or collection of servers can be used when the demand on computer system 1500 exceeds the reasonable capability of a single server or computer.

Meanwhile, in some embodiments, EVCS computer system 119 (FIG. 1) and/or EMS 111 may not have the level of sophistication and/or complexity of ETSN computer system 109 (FIG. 1), electric grid computer system 110 (FIG. 1), and/or intelligence module computer system 116 (FIG. 1). Likewise, intelligence module computer system 116 (FIG. 1) may not have the level of sophistication and/or complexity of ETSN computer system 109 (FIG. 1), electric grid computer system 110 (FIG. 1), and/or the OEM network computer system. For example, EVCS computer system 119 (FIG. 1), EMS 11 (FIG. 1), electric grid computer system 110 (FIG. 1), ETSN computer system 109 (FIG. 1), intelligence module computer system 116 (FIG. 1), and/or the OEM network computer system can have only those processing capabilities and/or memory storage capabilities as are reasonably necessary to perform the functionality, described above with respect to ETS 100 (FIG. 1), as applicable. In a more detailed example, EVCS computer system 119 (FIG. 1), EMS 111 (FIG. 1), and/or intelligence module computer system 116 (FIG. 1) could be implemented as a microcontroller comprising flash memory, or the like. Reducing the sophistication and/or complexity of any of EVCS computer system 119 (FIG. 1), EMS 111 (FIG. 1), electric grid computer system 110 (FIG. 1), ETSN computer system 109 (FIG. 1), intelligence module computer system 116 (FIG. 1), and/or the OEM network computer system can reduce the size and/or cost of implementing ETS 100 (FIG. 1), as applicable. Nonetheless, in other embodiments, any of EVCS computer system 119 (FIG. 1), EMS 111 (FIG. 1), electric grid computer system 110 (FIG. 1), ETSN computer system 109 (FIG. 1), intelligence module computer system 116 (FIG. 1), and/or the OEM network computer system may need additional sophistication and/or complexity to operate as desired.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 601-606 of FIG. 6, processes 701-707 of FIG. 7, activities 801-802 of FIG. 8, processes 901-905 of FIG. 9, procedures 1001-1008 of FIG. 10, processes 1101-1102 of FIG. 11, processes 1201-1202 of FIG. 12, activities 1301-1302 of FIG. 13, and/or procedures 1401-1403 of FIG. 14 may be comprised of many different procedures, processes, and activities and be performed by many different modules, in many different orders, that any element of FIGS. 1-16 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An electricity transfer system for modifying an electric vehicle charging station, the electric vehicle charging station (a) being configured to be coupled to an electric grid to receive electricity from the electric grid and (b) being configured to be coupled to an electric vehicle rechargeable energy storage system of an electric vehicle to make the electricity available to the electric vehicle rechargeable energy storage system, the electricity transfer system comprising:
an adapter configured (a) to be coupled to the electric vehicle charging station to receive the electricity from the electric vehicle charging station and (b) to be coupled to the electric vehicle rechargeable energy storage system to make the electricity available to the electric vehicle rechargeable energy storage system; and
an intelligence module configured to control the adapter;
wherein:
the electric vehicle charging station is configured to operate as a dumb electric vehicle charging station when the adapter is uncoupled from the electric vehicle charging station; and
when the adapter is coupled to the electric vehicle charging station, the electric vehicle charging station, the adapter, and the intelligence module operate as a smart electric vehicle charging station.

2. The electricity transfer system of claim 1 wherein:
the adapter comprises an operations module configured to be controlled by the intelligence module;
the operations module comprises an interruption mechanism configured to at least partially control at least one of (a) when the adapter receives the electricity from the electric vehicle charging station or (b) when the adapter makes the electricity available to the electric vehicle rechargeable energy storage system;
and
the electricity transfer system comprises a communication module configured to provide communication between the intelligence module and at least one of an electricity transfer system network computer system of an electricity transfer system network, an electric grid computer system of the electric grid, or an energy management system of the electric vehicle rechargeable energy storage system in order to permit the intelligence module, when controlling the operations module, to at least partially determine the at least one of (a) when the adapter receives the electricity from the electric vehicle charging station or (b) when the adapter makes the electricity available to the electric vehicle rechargeable energy storage system.

3. The electricity transfer system of claim 2 further comprising at least one of:
the electric vehicle charging station;
the electricity transfer system network computer system;
the electric grid computer system; or
the electric vehicle rechargeable energy storage system.

4. The electricity transfer system of claim 2 wherein:
the adapter is configured to condition the electricity that the adapter makes available to the electric vehicle rechargeable energy storage system.

5. The electricity transfer system of claim 1 wherein:
the adapter is portable.

6. The electricity transfer system of claim 1 wherein:
the electric vehicle charging station comprises an electrical connector configured (a) to be coupled to the electric vehicle charging station to receive the electricity from another portion of the electric vehicle charging station and (b) to be coupled to the electric vehicle rechargeable energy storage system to make the electricity available to the electric vehicle rechargeable energy storage system; and
the adapter is configured to be coupled to the electrical connector such that when the electrical connector is coupled to the electric vehicle charging station and the adapter is coupled to the electrical connector, the electrical connector couples the adapter to the electric vehicle charging station.

7. The electricity transfer system of claim 1 further comprising:
an electrical connector configured (a) to be coupled to the electric vehicle charging station to receive the electricity from the electric vehicle charging station and (b) to be coupled to the electric vehicle rechargeable energy storage system to make the electricity available to the electric vehicle rechargeable energy storage system; and
the adapter comprises the electrical connector.

8. The electricity transfer system of claim 1 wherein:
the adapter comprises at least one of a first locking mechanism or a second locking mechanism;
when the adapter is coupled to the electric vehicle charging station, the first locking mechanism is configured to prevent the adapter from being decoupled from the electric vehicle charging station; and
when the adapter is coupled to the electric vehicle rechargeable energy storage system, the second locking mechanism is configured to prevent the adapter from being decoupled from the electric vehicle rechargeable energy storage system.

9. The electricity transfer system of claim 1 wherein:
the adapter comprises the intelligence module.

10. The electricity transfer system of claim 1 wherein:
the adapter and the intelligence module are discrete from each other; and
at least one of (a) the intelligence module is configured to wirelessly communicate with the operations module or (b) the intelligence module is configured to be removably coupled with the adapter.

11. The electricity transfer system of claim 1 wherein:
the intelligence module comprises a user interface configured to operate the adapter.

12. The electricity transfer system of claim 11 wherein:
the user interface comprises a touch screen electronic display.

13. The electricity transfer system of claim 1 wherein:
the adapter comprises an operations module configured to be controlled by the intelligence module;
the operations module comprises an interruption mechanism configured to at least partially control at least one of (a) when the adapter receives the electricity from the electric vehicle charging station or (b) when the adapter makes the electricity available to the electric vehicle rechargeable energy storage system;
the intelligence module comprises a communication module configured to provide communication between the intelligence module and at least one of an electricity transfer system network computer system of an electricity transfer system network, an electric grid computer system of the electric grid, or an energy management system of the electric vehicle rechargeable energy storage system in order to permit the intelligence module, when controlling the operations module, to at least partially determine the at least one of (a) when the adapter receives the electricity from the electric vehicle charging station or (b) when the adapter makes the electricity available to the electric vehicle rechargeable energy storage system;
the electricity transfer system further comprises the electricity transfer system network computer system;
the adapter is portable and the adapter remains discrete from the electric vehicle charging station when the adapter is coupled to the electric vehicle charging station;
the electric vehicle charging station comprises an electrical connector configured (a) to be coupled to the electric vehicle charging station to receive the electricity from another portion of the electric vehicle charging station and (b) to be coupled to the electric vehicle rechargeable energy storage system to make the electricity available to the electric vehicle rechargeable energy storage system;
the adapter is configured to be coupled to the electrical connector such that when the electrical connector is coupled to the electric vehicle charging station and the adapter is coupled to the electrical connector, the electrical connector couples the adapter to the electric vehicle charging station;
the adapter comprises a first locking mechanism and a second locking mechanism;
when the adapter is coupled to the electric vehicle charging station, the first locking mechanism is configured to prevent the adapter from being decoupled from the electric vehicle charging station;
when the adapter is coupled to the electric vehicle rechargeable energy storage system, the second locking mechanism is configured to prevent the adapter from being decoupled from the electric vehicle rechargeable energy storage system; and
the intelligence module comprises a user interface configured to operate the adapter.

14. A method of providing an electricity transfer system for modifying an electric vehicle charging station, the electric vehicle charging station (a) being configured to be coupled to an electric grid to receive electricity from the electric grid and (b) being configured to be coupled to an electric vehicle rechargeable energy storage system of an electric vehicle to make the electricity available to the electric vehicle rechargeable energy storage system, the method comprising:
providing an adapter configured (a) to be coupled to the electric vehicle charging station to receive the electricity from the electric vehicle charging station and (b) to be coupled to the electric vehicle rechargeable energy storage system to make the electricity available to the electric vehicle rechargeable energy storage system; and
providing an intelligence module configured to control the adapter;
wherein:
the electric vehicle charging station is configured to operate as a dumb electric vehicle charging station when the adapter is uncoupled from the electric vehicle charging station; and
when the adapter is coupled to the electric vehicle charging station, the electric vehicle charging station, the adapter, and the intelligence module operate as a smart electric vehicle charging station.

15. The method of claim 14 wherein:
providing the adapter comprises providing an operations module configured to be controlled by the intelligence module;
providing the operations module comprises providing an interruption mechanism configured to at least partially control at least one of (a) when the adapter receives the electricity from the electric vehicle charging station or (b) when the adapter makes the electricity available to the electric vehicle rechargeable energy storage system;
and
the method further comprises providing a communication module configured to provide communication between the intelligence module and at least one of an electricity transfer system network computer system of an electricity transfer system network, an electric grid computer system of the electric grid, or an energy management system of the electric vehicle rechargeable energy storage system in order to permit the intelligence module, when controlling the operations module, to at least partially determine the at least one of (a) when the adapter receives the electricity from the electric vehicle charging station or (b) when the adapter makes the electricity available to the electric vehicle rechargeable energy storage system.

16. The method of claim 15 further comprising at least one of:
providing the electric vehicle charging station;
providing the electricity transfer system network computer system;
providing the electric grid computer system; or
providing the electric vehicle rechargeable energy storage system.

17. The method of claim 15 wherein:
providing the adapter comprises configuring the adapter to condition the electricity that the adapter makes available to the electric vehicle rechargeable energy storage system.

18. The method of claim 14 wherein:
providing the adapter comprises providing the adapter such that the adapter is portable.

19. The method of claim 14 wherein:
providing the adapter comprises configuring the adapter to be coupled to an electrical connector of the electric vehicle charging station, the electrical connector being configured (a) to be coupled to the electric vehicle charging station to receive the electricity from another portion of the electric vehicle charging station and (b) to be coupled to the electric vehicle rechargeable energy storage system to make the electricity available to the electric vehicle rechargeable energy storage system, such that when the electrical connector is coupled to the electric vehicle charging station and the adapter is coupled to the electrical connector, the electrical connector couples the adapter to the electric vehicle charging station.

20. The method of claim 14 wherein:
providing the adapter further comprises providing an electrical connector configured (a) to be coupled to the electric vehicle charging station to receive the electricity from the electric vehicle charging station and (b) to be coupled to the electric vehicle rechargeable energy storage system to make the electricity available to the electric vehicle rechargeable energy storage system.

21. The method of claim 14 wherein:
providing the adapter comprises providing at least one of a first locking mechanism of the adapter or a second locking mechanism of the adapter, wherein (a) when the adapter is coupled to the electric vehicle charging station, the first locking mechanism is configured to prevent the adapter from being decoupled from the electric vehicle charging station and (b) when the adapter is coupled to the electric vehicle rechargeable energy storage system, the second locking mechanism is configured to prevent the adapter from being decoupled from the electric vehicle rechargeable energy storage system.

22. The method of claim 14 wherein:
providing the adapter comprises providing the intelligence module.

23. The method of claim 14 wherein:
providing the intelligence module comprises:
providing the intelligence module to be discrete from the adapter; and
at least one of (a) configuring the intelligence module to wirelessly communicate with the operations module or (b) configuring the intelligence module to be removably coupled with the adapter.

24. The method of claim 14 wherein:
providing the intelligence module comprises providing a user interface configured to operate the adapter.

25. The method of claim 24 wherein:
providing the user interface comprises providing a touch screen electronic display.

26. A method for modifying a dumb electric vehicle charging station, the dumb electric vehicle charging station (a) being configured to be coupled to an electric grid to receive electricity from the electric grid and (b) being configured to be coupled to an electric vehicle rechargeable energy storage system of an electric vehicle to make the electricity available to the electric vehicle rechargeable energy storage system, the method comprising:
coupling an adapter to the dumb electric vehicle charging station to receive the electricity from the dumb electric vehicle charging station;
coupling the adapter to the electric vehicle rechargeable energy storage system to make the electricity available to the electric vehicle rechargeable energy storage system; and
after coupling the adapter to the dumb electric vehicle charging station and after coupling the adapter to the electric vehicle rechargeable energy storage system, controlling the adapter such that the dumb electric vehicle charging station and the adapter operate as a smart electric vehicle charging station.

27. The method of claim 26 wherein:
controlling the adapter comprises:
controlling at least one of (a) when the adapter receives the electricity from the dumb electric vehicle charging station or (b) when the adapter makes the electricity available to the electric vehicle rechargeable energy storage system;
and
communicating with at least one of an electricity transfer system network computer system of an electricity transfer system network, an electric grid computer system of the electric grid, or an energy management system of the electric vehicle rechargeable energy storage system to at least partially determine the at least one of (a) when the adapter receives the electricity from the dumb electric vehicle charging station or (b) when the adapter makes the electricity available to the electric vehicle rechargeable energy storage system.

28. The method of claim 26 further comprising at least one of:
decoupling the adapter from the dumb electric vehicle charging station; or
decoupling the adapter from the electric vehicle rechargeable energy storage system.

29. The method of claim 26 wherein:
coupling the adapter to the dumb electric vehicle charging station comprises coupling the adapter to an electrical connector configured (a) to be coupled to the dumb electric vehicle charging station to receive the electricity from the dumb electric vehicle charging station and (b) to be coupled to the electric vehicle rechargeable energy storage system to make the electricity available to the electric vehicle rechargeable energy storage system.

30. The method of claim 26 further comprising at least one of:
preventing the adapter from being decoupled from the dumb electric vehicle charging station; or
preventing the adapter from being decoupled from the electric vehicle rechargeable energy storage system.

31. The method of claim 26 wherein:
controlling the adapter comprises operating a user interface of the adapter.

32. A method of supporting an adapter for modifying a dumb electric vehicle charging station such that the dumb electric vehicle charging station and the adapter operate as a smart electric vehicle charging station, the dumb electric vehicle charging station (a) being configured to be coupled to an electric grid to receive electricity from the electric grid and (b) being configured to be coupled to an electric vehicle rechargeable energy storage system of an electric vehicle to make the electricity available to the electric vehicle rechargeable energy storage system, the method comprising:
maintaining an electricity transfer system network computer system of an electricity transfer system network; and
communicating with the adapter, the adapter being configured to control at least one of (a) when the adapter receives the electricity from the dumb electric vehicle charging station or (b) when the adapter makes the electricity available to the electric vehicle rechargeable energy storage system, in order to determine the at least one of (a) when the adapter receives the electricity from the dumb electric vehicle charging station or (b) when the adapter makes the electricity available to the electric vehicle rechargeable energy storage system.

33. The method of claim 32 further comprising:
facilitating use of the dumb electric vehicle charging station, wherein the electricity transfer system network comprises the dumb electric vehicle charging station.
